(19) United States
(12) Patent Application Publication
(10) Pub. No.: US 2019/0230723 A1
(43) Pub. Date: Jul. 25, 2019

(54) METHOD FOR PERFORMING SERVICE REQUEST PROCEDURE IN WIRELESS COMMUNICATION SYSTEM AND DEVICE THEREFOR

(71) Applicant: LG ELECTRONICS INC., Seoul (KR)

(72) Inventors: Taehun KIM, Seoul (KR); Jaewook LEE, Seoul (KR)

(73) Assignee: LG ELECTRONICS INC., Seoul (KR)

(21) Appl. No.: 16/330,738

(22) PCT Filed: Sep. 5, 2017
(86) PCT No.: PCT/KR2017/009707

§ 371 Date: Mar. 5, 2019

Related U.S. Application Data
(60) Provisional application No. 62/383,584, filed on Sep. 5, 2016.
(60) Provisional application No. 62/406,958, filed on Oct. 12, 2016.

(51) Int. Cl. H04W 76/10

(52) U.S. Cl. CPC H04W 76/10; H04W 88/04

(57) ABSTRACT

Disclosed are a method for performing a service request procedure in a wireless communication system and an apparatus therefore. Specifically, a method for performing, by a base station, a service request procedure triggered by a remote UE when a connection between a relay user equipment (UE) and a remote UE is set up in a wireless communication system may include: receiving, from the relay UE, a radio resource management (RRC) message encapsulated with a service request message for the remote UE, which includes an identifier of the remote UE; transmitting the service request message to a mobile management entity (MME) within an S1 interface message; receiving, from the MME, an S1 initial context setup request message for the remote UE without UE radio capability information of the remote UE; and storing the UE radio capability information of the relay UE as the UE radio capability information of the remote UE.

### TECHNICAL FIELD

The present invention relates to a wireless communication system, and more particularly, to a method for performing a signaling procedure for layer 2 relaying when a connection between a remote user equipment (UE) and a relay UE is set up and an apparatus for supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

The present invention provides a method for performing a signaling procedure for layer 2 relaying when a connection between a remote UE (e.g., a wearable device, etc.) and a relay UE is set up.

Furthermore, the present invention provides a method for performing a service request procedure for a remote UE and/or a relay UE when a connection between a remote UE and a relay UE is set up.

Furthermore, the present invention provides a method for performing a paging procedure a remote UE and/or a relay UE when a connection between a remote UE and a relay UE is set up.

Furthermore, the present invention provides a method for performing a tracking area update procedure for a remote UE and/or a relay UE when a connection between a remote UE and a relay UE is set up.

The technical objects of the present invention are not limited to the aforementioned technical objects, and other technical objects, which are not mentioned above, will be apparently appreciated by a person having ordinary skill in the art from the following description.

### Technical Solution

In an aspect, a method for performing, by a base station, a service request procedure triggered by a remote UE when a connection between a relay user equipment (UE) and a remote UE is set up in a wireless communication system may include: receiving, from the relay UE, a radio resource management (RRC) message encapsulated with a service request message for the remote UE, which includes an identifier of the remote UE; transmitting the service request message to a mobile management entity (MME) within an S1 interface message; receiving, from the MME, an S1 initial context setup request message for the remote UE without UE radio capability information of the remote UE; and storing the UE radio capability information of the relay UE as the UE radio capability information of the remote UE.

In another aspect, a base station performing a service request procedure triggered by a remote UE when a connection between a relay user equipment (UE) and a remote UE is set up in a wireless communication system may include: a communication module transmitting/receiving a signal; and a processor controlling the communication module, in which the processor may be configured to receive, from the relay UE, a radio resource management (RRC) message encapsulated with a service request message for the remote UE, which includes an identifier of the remote UE, transmit the service request message to a mobile management entity (MME) within an S1 interface message, receive, from the MME, an S1 initial context setup request message for the remote UE without UE radio capability information of the remote UE, and store the UE radio capability information of the relay UE as the UE radio capability information of the remote UE.

Preferably, the S1 interface initial context setup request message may include an indicator indicating that the remote UE is connected to the relay UE and the relay UE transmits/receives traffic of the remote UE, or the identifier of the relay UE and/or the identifier of the remote UE.

Preferably, a radio bearer setup procedure for the relay UE and the remote UE may be performed based on the UE radio capability information of the relay UE.

Preferably, the radio bearer setup may include transmitting, to the relay UE, an RRC connection reconfiguration for modifying an RRC connection, and receiving, from the relay UE, an RRC connection reconfiguration complete message for confirming successful completion of RRC connection reconfiguration.

Preferably, when a paging message for the remote UE is transmitted to the relay UE, transmission of the service request message may be triggered.

Preferably, in a case where the paging message for the remote UE is transmitted to the relay UE, when the relay UE determines that communication with the remote UE is impossible, it may be notified from the relay UE to a network that the communication with the remote UE is impossible.

Preferably, when the paging message for both the relay UE and the remote UE is transmitted to the relay UE, the transmission of the service request message may be triggered, and the paging message may include a group identifier for the relay UE and the remote UE.

Preferably, when the relay UE receives, from the remote UE, a signaling or data which the remote UE is to transmit through the network, the transmission of the service request message may be triggered.

Preferably, when the relay UE receives, from the remote UE, an indication for indicating that there is the signaling or data which the remote UE is to transmit through the network, the transmission of the service request message may be triggered.

Preferably, when the S1 interface initial context setup request message for the relay UE is received following the S1 interface initial context setup request message for the remote UE within the service request procedure, an indication for indicating that the S1 interface initial context setup request message for the relay UE following the S1 interface initial context setup request message for the remote UE may be included.

Preferably, when the S1 interface initial context setup request message for the remote UE and the S1 interface initial context setup request message for the relay UE is received are transmitted as a single message, the identifier of the remote UE and the identifier of the relay UE may be included in the single message and an information element may be separately included for each identifier.

Preferably, the relay UE may be in an evolved packet system (EPS) mobility management (EMM)-idle mode or EMM-connected mode.

Preferably, the service request message may include an indicator or an active flag for requesting establishment of a data radio bearer for the remote UE.

### Advantageous Effects

According to an embodiment of the present invention, a signaling procedure (RRC signaling and/or NAS signaling) for a remote UE and/or a relay UE can be efficiently performed in a layer 2 relaying environment.

In particular, according to an embodiment of the present invention, an effective signaling procedure (RRC signaling and/or NAS signaling) can be defined by considering that communication of a remote UE is dependent on a capability of a relay UE in a layer 2 relaying environment.

Advantages which can be obtained in the present invention are not limited to the aforementioned effects and other unmentioned advantages will be clearly understood by those skilled in the art from the following description.

### DESCRIPTION OF DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a diagram schematically exemplifying an evolved packet system (EPS) to which the present invention can be applied.

FIG. 2 illustrates an example of evolved universal terrestrial radio access network structure to which the present invention can be applied.

FIG. 3 exemplifies a structure of E-UTRAN and EPC in a wireless communication system to which the present invention can be applied.

FIG. 4 illustrates a structure of a radio interface protocol between a UE and E-UTRAN in a wireless communication system to which the present invention can be applied.

FIG. 5 is a diagram schematically showing a structure of a physical channel in a wireless communication system to which the present invention may be applied.

FIG. 6 is a diagram for describing a contention based random access procedure in a wireless communication system to which the present invention may be applied.

FIG. 7 is a diagram illustrating a UE trigger service request procedure in a wireless communication system to which the present invention may be applied.

FIG. 8 is a diagram illustrating a network triggered service request procedure in a wireless communication system to which the present invention may be applied.

FIGS. 9 and 10 are diagrams illustrating a service request procedure in a wireless communication system to which the present invention may be applied.

FIG. 11 illustrates a procedure of establishing a safe layer-2 link through a PC5 interface in a wireless communication system to which the present invention may be applied.

FIG. 12 illustrates a procedure of releasing a layer-2 link through a PC5 interface in a wireless communication system to which the present invention may be applied.

FIG. 13 is a diagram illustrating a UE network capability information element in a wireless communication system to which the present invention may be applied.

FIG. 14 illustrates an initial context setup procedure in a wireless communication system to which the present invention may be applied.

FIG. 15 illustrates an initial context setup procedure in a wireless communication system to which the present invention may be applied.

FIG. 16 is a diagram illustrating a layer-2 relay operation in a wireless communication system to which the present invention may be applied.

FIG. 17 is a diagram illustrating a method for exchanging capability information between a remote UE and a relay UE according to an embodiment of the present invention.

FIG. 18 is a diagram schematically illustrating a service request procedure according to an embodiment of the present invention.

FIG. 19 is a diagram illustrating a signaling flow of a layer-2 relay in a wireless communication system to which the present invention may be applied.

FIG. 20 is a diagram illustrating a service request procedure according to an embodiment of the present invention.

FIG. 21 illustrates a paging procedure for a layer-2 relay according to an embodiment of the present invention.

FIG. 22 illustrates a tracking area update procedure for a layer-2 relay according to an embodiment of the present invention.

FIG. 23 illustrates a block diagram of a communication apparatus according to an embodiment of the present invention.

FIG. 24 illustrates a block diagram of a communication apparatus according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.
Universal Mobile Telecommunication System (UMTS): the 3rd generation mobile communication technology based on GSM, developed by the 3GPP
Evolved Packet System (EPS): a network system comprising an Evolved Packet Core (EPC), a packet switched core network based on the Internet Protocol (IP) and an access network such as the LTE and UTRAN. The EPS is a network evolved from the UMTS.
NodeB: the base station of the UMTS network. NodeB is installed outside and provides coverage of a macro cell.
eNodeB: the base station of the EPS network. eNodeB is installed outside and provides coverage of a macro cell.
User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.
IP Multimedia Subsystem (IMS): a sub-system providing multimedia services based on the IP
International Mobile Subscriber Identity (IMSI): a globally unique subscriber identifier assigned in a mobile communication network
Machine Type Communication (MTC): communication performed by machines without human intervention. It may be called Machine-to-Machine (M2M) communication.
MTC terminal (MTC UE or MTC device): a terminal (for example, a vending machine, meter, and so on) equipped with a communication function operating through a mobile communication network (For example, communicating with an MTC server via a PLMN) and performing an MTC function
MTC server: a server on a network managing MTC terminals. It may be installed inside or outside a mobile communication network. It may provide an interface through which an MTC user may access the server. Also, an MTC server may provide MTC-related services to other servers (in the form of Services Capability Server (SCS)) or the MTC server itself may be an MTC Application Server.
(MTC) application: services (to which MTC is applied) (for example, remote metering, traffic movement tracking, weather observation sensors, and so on)
(MTC) Application Server: a server on a network in which (MTC) applications are performed
MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.
MTC User (MTC User): The MTC user uses the service provided by the MTC server.
MTC subscriber: an entity having a connection relationship with a network operator and providing services to one or more MTC terminals.
MTC group: an MTC group shares at least one or more MTC features and denotes a group of MTC terminals belonging to MTC subscribers.
Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.
External identifier: a globally unique identifier used by an external entity (for example, an SCS or an Application Server) of the 3GPP network to indicate (or identify) an MTC terminal (or a subscriber to which the MTC terminal belongs). An external identifier includes a domain identifier and a local identifier as described below.
Domain identifier: an identifier used for identifying a domain in the control region of a mobile communication network service provider. A service provider may use a separate domain identifier for each service to provide an access to a different service.
Local identifier: an identifier used for deriving or obtaining an International Mobile Subscriber Identity (IMSI). A local identifier should be unique within an application domain and is managed by a mobile communication network service provider.
Radio Access Network (RAN): a unit including a Node B, a Radio Network Controller (RNC) controlling the Node B, and an eNodeB in the 3GPP network. The RAN is defined at the terminal level and provides a connection to a core network.
Home Location Register (HLR)/Home Subscriber Server (HSS): a database provisioning subscriber information within the 3GPP network. An HSS may perform functions of configuration storage, identity management, user state storage, and so on.
RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).
Public Land Mobile Network (PLMN): a network formed to provide mobile communication services to individuals. The PLMN may be formed separately for each operator.
Service Capability Exposure Function (SCEF): An entity within the 3GPP architecture for service capability exposure that provides a means for securely exposing services and capabilities provided by 3GPP network interfaces.

In what follows, the present invention will be described based on the terms defined above.

Overview of System to which the Present Invention May be Applied

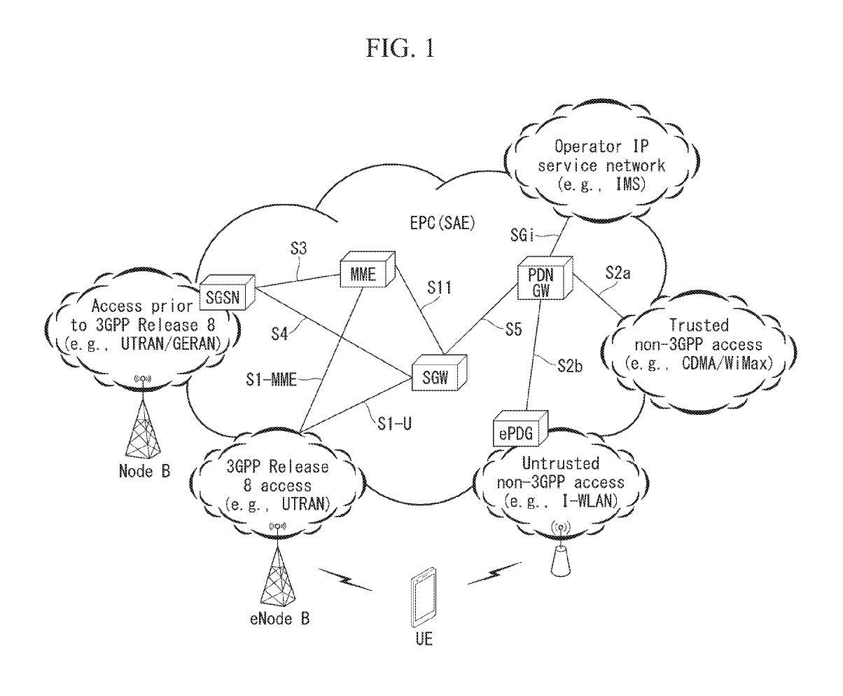

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability may access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| reference | |
|---|---|
| point | Description |
| S1- | Reference point for the control plane protocol between E- |
| MME | UTRAN and MME |
| S1-U | Reference point between E-UTRAN and Serving GW for the |
| | per bearer user plane tunneling and inter eNodeB path |
| | switching during handover |
| S3 | It enables user and bearer information exchange for inter |
| | 3GPP access network mobility in idle and/or active state. |
| | This reference point may be used intra-PLMN or inter-PLMN |
| | (e.g. in the case of Inter-PLMN HO). |
| S4 | It provides related control and mobility support between |
| | GPRS core and the 3GPP anchor function of Serving GW. In |
| | addition, if direct tunnel is not established, it provides the user |
| | plane tunneling. |
| S5 | It provides user plane tunneling and tunnel management |
| | between Serving GW and PDN GW. It is used for Serving |
| | GW relocation due to UE mobility if the Serving GW needs |
| | to connect to a non-collocated PDN GW for the required PDN |
| | connectivity. |
| S11 | Reference point for the control plane protocol between MME |
| | and SGW |
| SGi | It is the reference point between the PDN GW and the packet |
| | data network. Packet data network may be an operator |
| | external public or private packet data network or an intra- |
| | operator packet data network (e.g., for provision of IMS |
| | services). This reference point corresponds to Gi for 3GPP |
| | accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

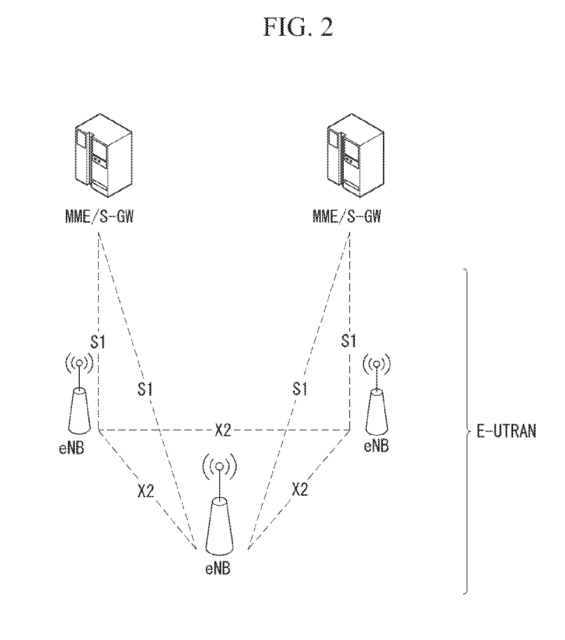

FIG. 2 illustrates one example of an Evolved Universal Terrestrial Radio Access Network (E-UTRAN) to which the present invention may be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

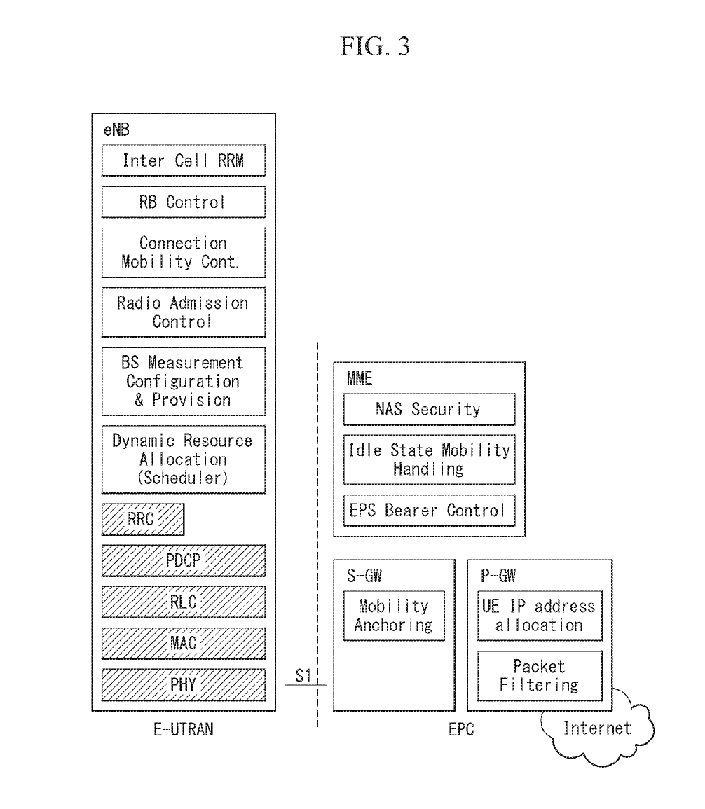

FIG. 3 exemplifies a structure of E-UTRAN and EPC in a wireless communication system to which the present invention may be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

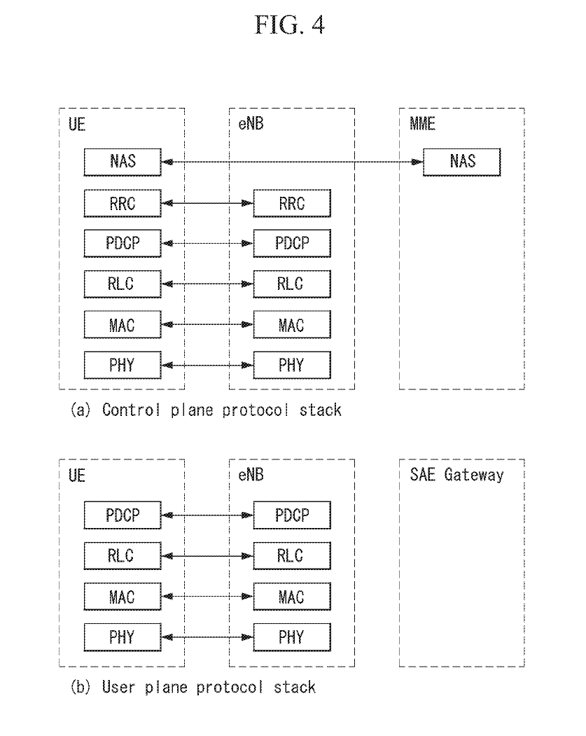

FIG. 4 illustrates a radio interface protocol structure between a UE and an E-UTRAN in a wireless communication system to which the present invention may be applied.

FIG. 4(a) illustrates a radio protocol structure for the control plane, and FIG. 4(b) illustrates a radio protocol structure for the user plane.

Referring to FIG. 4, layers of the radio interface protocol between the UE and the E-UTRAN may be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, if MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, reconfiguration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

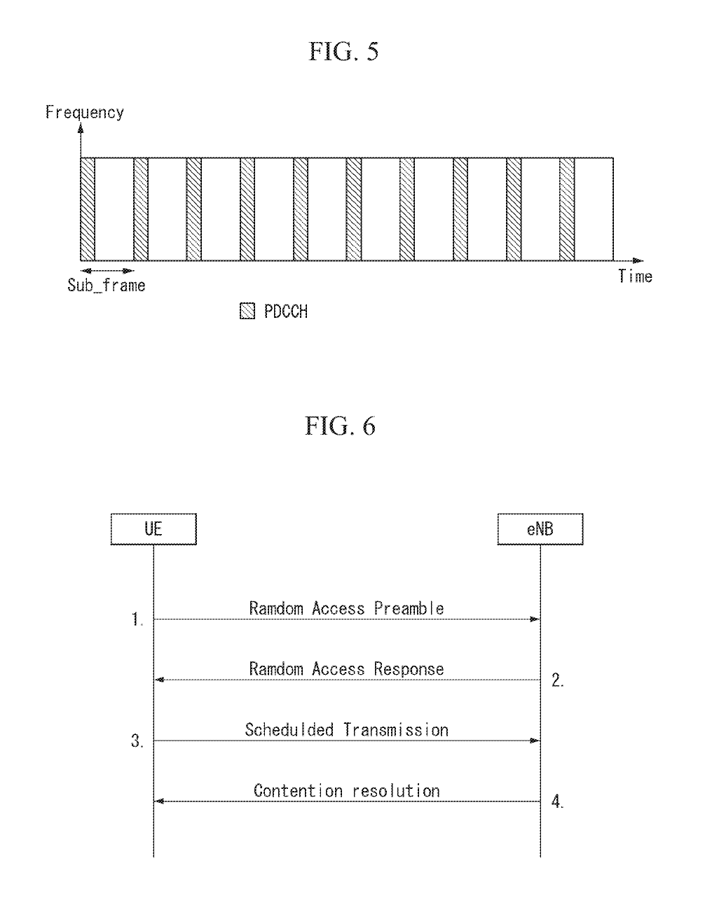

FIG. 5 is a diagram schematically exemplifying a structure of physical channel in a wireless communication system to which the present invention may be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

FIG. 6 is a diagram for describing the contention-based random access procedure in the wireless communication system to which the present invention may be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (for example, SAE temporary mobile subscriber identity (S-TMSI) or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

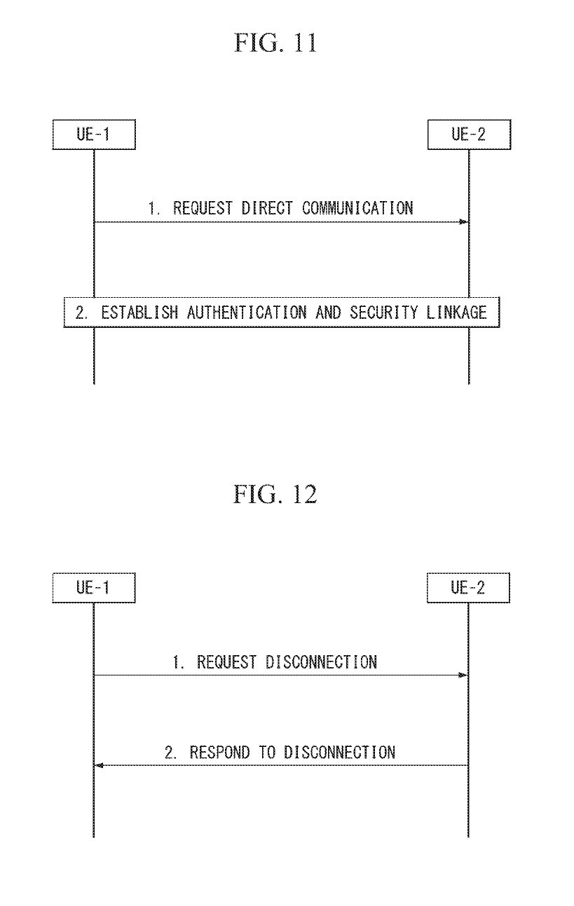

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

Terms used in this specification are described below.
Dedicated bearer: an EPS bearer associated with an uplink packet filter(s) within a UE and a downlink packet filter(s) within a P-GW. In this case, only a specific packet is matched with the filter(s).
Default bearer: an EPS bearer established even new PDN connection. Context of a default bearer is maintained during the lifetime of a PDN connection.
EPS mobility management (EMM)-EMM-NULL state: an EPS service within a UE is deactivated. Any EPS mobility management function is not performed.
EMM-DEREGISTERED state: in the EMM-DEREGISTERED state, EMM context is not established and an MME is not notified of a UE location. Accordingly, the UE is unreachable by the MME. In order to establish EMM context, the UE needs to start an Attach or combined Attach procedure.
EMM-REGISTERED state: In the EMM-REGISTERED state, EMM context within a UE has been established and default EPS bearer context has been activated.

When a UE is in the EMM-IDLE mode, an MME is notified of a UE location with accuracy of a list of TAs including a specific number of a TA. The UE may initiate the transmission and reception of user data and signaling information and may respond to paging. Furthermore, a TAU or combined TAU procedure is performed.
EMM-CONNECTED mode: when an NAS signaling connection is set up between a UE and a network, the UE is the EMM-CONNECTED mode. The term “EMM-CONNECTED” may be referred to as a term “ECM-CONNECTED state.”
EMM-IDLE mode: when an NAS signaling connection is not present between a UE and a network (i.e., an EMM-IDLE mode without suspend indication) or RRC connection suspend is indicated by a lower layer (i.e., an EMM-IDLE mode with suspend indication), the UE is in the EMM-IDLE mode. The term “EMM-IDLE” may be referred to as a term “ECM-IDLE state.”
EMM context: when an Attach procedure is successfully completed, EMM context is established between a UE and an MME.
Control plane CIoT EPS optimization: signaling optimization that enables the efficient transport of user data (IP, non-IP or SMS) through a control plane via an MME. This may optionally include the header compression of IP data.
User plane CIoT EPS optimization: signaling optimization that enables the efficient transport of user data (IP or non-IP) through a user plane.
EPS service(s): a service(s) provided by a PS domain.
NAS signaling connection: a peer-to-peer S1 mode connection between a UE and an MME. An NAS signaling connection has a concatenation of an RRC connection via an LTE-Uu interface and an S1AP connection via an S1 interface.
UE using EPS services with control plane CIoT EPS optimization: UE attached for EPS services with control plane CIOT EPS optimization approved by a network
Non-access stratum (NAS): a functional layer for exchanging an UMTS, signaling between a UE and a core network in an EPS protocol stack, and a traffic message. This has a main function of supporting the mobility of a UE and supporting a session management procedure of establishing and maintaining an IP connection between a UE and a PDN GW.
Access stratum (AS): this means a protocol layer under the NAS layer on the interface protocol between an E-UTRAN (eNB) and a UE or between an E-UTRAN (eNB) and an MME. For example, in the control plane protocol stack, the RRC layer, PDCP layer, RLC layer, MAC layer and PHY layer may be collectively referred to as an AS layer or any one of the layers may be referred to as an AS layer. Or, in the user plane protocol stack, the PDCP layer, RLC layer, MAC layer and PHY layer may be collectively referred to as an AS layer or any one of the layers may be referred to as an AS layer.
S1 mode: a mode applied to a system having functional separation according to the use of an S1 interface between a radio access network and a core network. The S1 mode includes a WB-S1 mode and an NB-S1 mode.
NB-S1 mode: this mode is applied by a UE when a serving radio access network of the UE provides access to a network service (via E-UTRA) based on a narrow band (NB)-Internet of things (IoT).
WB-S1 mode: this mode is applied when a system operates in the S1 mode, but is not the NB-S1 mode.

Service Request Procedure

1) UE Triggered Service Request

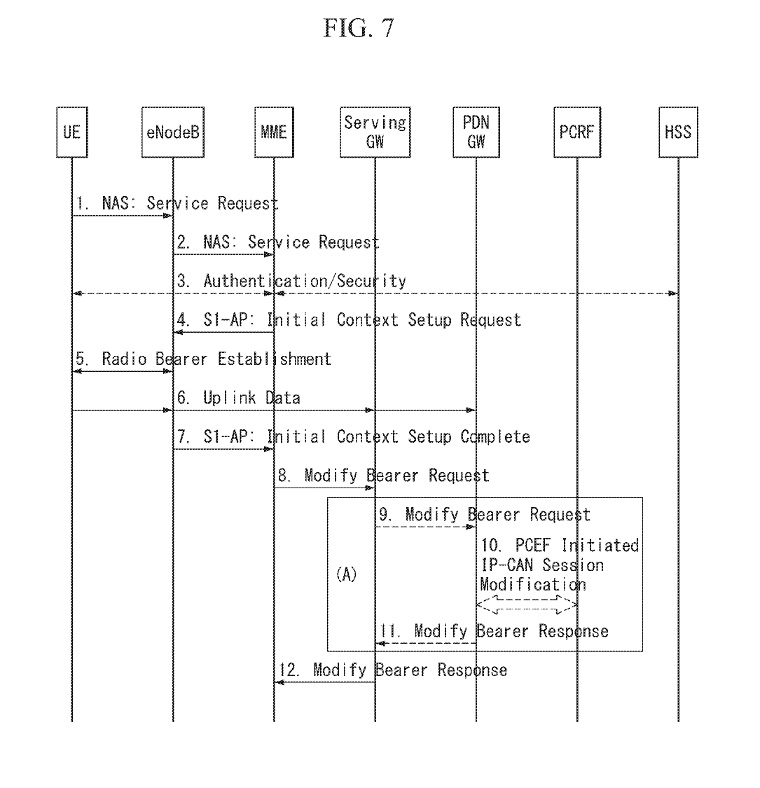

FIG. 7 is a diagram illustrating a UE trigger service request procedure in a wireless communication system to which the present invention may be applied.

A service request procedure illustrated in FIG. 7 is triggered by a UE in an ECM-IDLE state in order to establish a user plane radio bearer(s) for the UE.

Although the UE applies control plane (cellular Internet of things) EPS optimization, the UE in the ECM-IDLE state may use such a procedure in order to establish the user plane radio bearer when the UE and the MME supports user plane EPS optimization in addition to the control plane CIoT EPS optimization.

The UE transmits to the MME a service request which is an NAS message encapsulated in the RRC message the eNB.

2. The eNB delivers the NAS message to the MME. The NAS message is encapsulated in an initial UE message which is an S1-AP message.

The initial UE message includes a NAS message (e.g., the service request message), a tracking area identity (TAI) and an E-UTRAN cell global identifier (ECGI) of the serving cell, an SAE-temporary mobile subscriber identity (S-TMSI), a closed subscriber group (CSG) identifier (ID), a CSG access mode, and an RRC establishment cause.

When the MMR may not process the service request, the MMR rejects the service request. The CSG ID is provided when the UE transmits a Service Request message through a CSG cell or a hybrid cell. The CSG mode is provided when the UE transmits the Service Request message through the hybrid cell. When the CSG access mode is not provided and the CSG ID is provided, the MME regards the CSG ID as the CSG cell.

When the CSG ID is indicated and the CSG access mode is not provided and there is no subscription data for the CSG ID and the associated PLMN or CSG subscription has expired, the MME rejects the Service Request for an appropriate cause. When the UE initiates a service request procedure from an allowed CSG list, the UE removes PLMN associated with the CSG ID of the cell.

In a case where a UE has an emergency bearer (that is, when at least one EPS bearer is reserved with an allocation and retention priority (ARP) for an emergency service), when the UE may not receive a normal service due to a CSG access restriction, the MME deactivates all non-emergency bearers and accepts the service request.

When a local Internet protocol (IP) access is activated for packet data network (PDN) connection and when a cell accessed by the UE is not linked to a local gateway (L-gateway) which initiates LIPA PDN connection, the MME requests disconnection of the LIPA PDN connection without requesting establishment of the bearer of the LIPA PDN connection to the eNB in step 4. When the UE does not have another PDN connection, the MME rejects the service request with an appropriate cause value. Consequently, the UE is detached, the subsequent process is omitted, and release of a core network resource is initiated according to an MME-initiated detach procedure.

When an “availability after DDN failure” monitoring event or a “UE reachability” monitoring event is configured in the MME with respect to the UE, the MME transmits an event notification.

3. The NAS authentication/security procedure may be performed.

4. The MME deletes S11-U related information in the UE context. In this case, the S11-U related information may include a tunnel endpoint identifier (TEID) (downlink) for S11-U for control plane CIoT EPS optimization and a robust header compression (ROHC) context for the control plane CIoT EPS optimization if data in the MME is buffered, but does not include a header compression configuration.

The MME transmits the S1-AP initial context setup request message to the eNB.

The initial context setup request message includes an S-GW address, S1-TEID(s) (uplink), EPS bearer QoS(s), a security context, an MME signaling connection identifier, a handover restriction list, and a CSG membership indication.

When there is a PDN connection established for LIPA, the message includes a Correlation ID for enabling a direct user plane path between the Home eNB (HeNB) and the L-GW.

When there is a PDN connection established for the selected IP Traffic Offload (SIPTO) in the local network with an L-GW function collocated with the eNB, the message includes an SIPTO correlation ID for enabling the direct user plane path between the (H)eNB and the L-GW.

The radio and S1 bearers for all activated EPS bearers are activated. The eNB stores a security context, an MME signaling connection identifier, an EPS bearer QoS(s), and S1-TEID(s) in the UE RAN context. When the access is not granted to a cell in which the UE initiates the service request procedure due to the CSG access restriction, the MME needs to request only emergency EPS bearer establishment.

When the service request is performed through the hybrid cell, the CSG membership indication for indicating whether the UE is a CSG member is included in the S1-AP message delivered from the MME to the RAN. Based on the information, the RAN may differently handle a CSG member and a non-CSG member.

5. The eNB performs a radio bearer establishing procedure. User plane security is established at this step. When the user plane radio bearer is set up, EPS bearer state synchronization between the UE and the network is performed. That is, the UE locally deletes the EPS bearer for the radio bearer which is not set up. In addition, the radio bearer for a primary EPS bearer is not established, the UE locally deactivates all EPS bearers associated with the primary EPS bearer.

Uplink data may be now delivered to the S-GW from the UE by the eNB. The eNB transmits the uplink data to the S-GW address and TEID provided in step 4. The S-GW transmits the uplink data to the P-GW.

The eNB transmits an initial context setup complete message which is the S1-AP message to the MME. The initial context setup complete message includes an eNB address, the list of accepted EPS bearers, the list of rejected EPS bearers, and the S1 TEID(s) (downlink). When the correlation ID or SIPTO correlation ID is included in step 4, the eNB uses the included information in order to establish the direct user plane path to the L-GW and deliver the uplink data for the LIPA or SIPTO in the local network having the L-GW function collocated with the (H)eNB.

The MME transmits a modify bearer request message to the S-GW for each PDN connection. The modify bearer request message includes the eNB address, the S1 TEID(s) (downlink) for the accepted EPS bearer, a delay downlink packet notification request, an RAT type, and an RRC establishment cause. The S-GW supports a modify access bearers request procedure and further, when the S-GW need not transmit the signaling to the P-GW, the MME transmits a modify access bearers request message to the S-GW for each UE for signaling optimization. The modify access bearers request message includes the eNB address(es), the S1 TEID(s) for a downlink user plane for the accepted EPS bearer and the delay downlink packet notification request. The S-GW may now transmit downlink data to the UE. When the P-GW requests a location and/or user CSG information of the UE and the location and/or user CSG information of the UE is changed, the MME makes a user location information element (IE) and/or a user CSG information IE be included in the message. When Idle Mode Signaling Reduction (ISR) is activated or when a Serving Network IE is changed against a last reported Serving Network IE, the MME makes the Serving Network IE be included in this message. When a UE time zone is changed against a last reported UE time zone, the MME makes a UE time zone IE be included in the message. When Pending Network Initiated PDN Connection Signaling which is an internal flag, is set, the MME indicates an available UE for end-to-end signaling in the Modify Bearer Request message and resets the flag. Only when the RRC establishment cause is set to “Mobile Originated (MO) exception data” and the UE accesses through the Narrow Band Internet of Things (NB-IoT), the MME makes the RRC establishment cause be included.

When any downlink data buffered for the UE using a power saving function is already delivered and a downlink (DL) data buffer expiration time in the UE contexts of the MME and the S-GW is set in order to prevent the user plane from being unnecessarily set up together with a subsequent tracking area update (TAU), the MME and the S-GW delete the DL data buffer expiration time.

When the primary EPS bearer is not accepted by the ENB, all EPS bearers associated with the primary bearer are treated as non-accepted bearers. The MME triggers a bearer release procedure to release the non-accepted bearer. When the S-GW receives a downlink packet for the non-accepted bearer, the S-GW drops the corresponding downlink packet and does not transmit a downlink data notification to the MME.

9. When the RAT type is changed compared to the last reported RAT type or when in step 8, a location and/or information IE and/or UE Time Zone and/or ISR of the UE are not activated and there is the serving network ID and/the indication of the UE available for the end-to-end signaling, the S-GW transmits the Modify Bearer Request message to the P-GW for each PDN connection. The Modify Bearer Request includes the RAT type and the RRC establishment cause. Further, when there is the Modify Bearer Request message in step 8, the Modify Bearer Request message includes the user location information IE and/or the user CSG information IE and/or the Serving Network IE and/or the UE time zone, and/or the UE indication available for the end-to-end signaling.

When the Modify Bearer Request message is not transmitted and P-GW charging is paused due to such a reason, the S-GW transmits the Modify Bearer Request message accompanied by a PDN Charging Pause Stop Indication in order to inform the P-GW that charging is not paused any longer. The message does not include other IEs.

When the Modify Bearer Request message is not transmitted and the MME indicates the RRC establishment cause with “MO exception data”, the S-GW informs the P-GW that the RRC establishment cause is used.

The S-GW instructs a Charging Data Record (CDR) to use the RRC establishment cause.

10. When Dynamic Policy and Charging Control (PCC) is used, the P-GW interacts with a policy and charging rules function (PCRF) by using a PCEF initiated Internet Protocol Connectivity Access Network (IP-CAN) Session Modification procedure in order to obtain a PCC rule(s) according to the RAT type. When the dynamic PCC is not used, the P-GW may apply a local QoS policy.

The P-GW instructs the CDR to use the RRC establishment cause with the “MO exception data”.

11. The P-GW transmits a Modify Bearer Response message to the S-GW.

12. The S-GW transmits the Modify Bearer Response message to the MME in response to the Modify Bearer Request message. The Modify Bearer Response message includes the S-GW address and the TEID for the uplink traffic. When a Proxy Mobile Internet Protocol (PMIP) is used on an S5/S8 interface, in a case where the S-GW may not service an MME request in Modify Access Bearers Request without S5/S8 signaling or without corresponding Gxc signaling in addition to releasing the charging pausing in the P-GW, the S-GW responds to the MME with an indication that modification is not restricted to the S1-U bearer and the MME repeats a request thereof by using the Modify Access Bearer Request message for each PDN connection.

When the SIPTO is activated in the local network for the PDN connection using a stand-alone gateway deployment and a Local Home Network ID is a Local Home Network ID for the SIPTO@LN PDN connection initiated by the UE, the MME requests the disconnection of the SIPTO at the local network PDN connection(s) using a “reactivation requested” cause value. When the UE does not have another PDN connection, the MME initiates an “explicit detach with reattach required” procedure.

When the SIPTO is activated in the local network for the PDN connection using a collocated L-GW deployment and an L-GW core network address of the cell connected by the UE is different from an L-GW core network address of the cell in which the UE initiates the SIPTO in the local network PDN connection, the MME requests the disconnection of the SIPTO at the local network PDN connection(s) using the “reactivation requested” cause value. When the UE does not have another PDN connection, the MME initiates the “explicit detach with reattach required” procedure.

2) Abnormal Situation Control in UE Triggered Service Request

Under a specific condition, a current UE triggered Service Request procedure may cause an unnecessary Downlink Packet Notification message to increase an MME load.

This may occur when the uplink data transmitted in step 6 of FIG. 7 above causes a downlink response which arrives at the S-GW before the Modify Bearer Request message in step 8. The data may not be delivered from the S-GW to the eNB, and as a result, the Downlink Data Notification message is triggered.

When the MME receives the Downlink Data Notification from step 2 to a step before step 9, the MME does not transmit an S1 interface paging message. However, the MME monitors a ratio at which such an event occurs with respect to all UEs registered in the MME. When the ratio significantly increases and the load of the MME exceeds a set value, the MME instructs to the S-GW the “Delay Downlink Packet Notification Request” having a parameter D. Here, D represents a requested delay given by an integer multiple of 50 ms or 0. The S-GW then uses the delay between downlink data reception and Downlink Data Notification message transmission.

The MME uses the Modify Access Bearer Request or the Modify Bearer Request in step 8 in the UE initiated Service Request procedure to instruct to the S-GW the “Delay Downlink Packet Notification Request”.

In order to determine an amount of delay required by the MME, the S-GW uses the last Modify Access Bearers Request or Modify Bearer Request message or the S-GW receives the Modify Access Bearer Request Modify Bearer Request received within previous 30 seconds. The MME serves to set a value of the D.

In general, when a downlink data packet without a downlink TEID (DL-TEID) of an S1 user plane tunnel is received, the S-GW transmits the Downlink Data Notification message to the MME without delay.

When the S-GW determines from the last Modify Access Bearer Request or Modify Bearer Request message that the MME requests a delay of Downlink Packet Notification by a delay of D, the S-GW buffers the downlink data during a D period. When the DL-TEID and the eNB address are received before a timer expires, the timer is canceled and a network triggered service request procedure is completed without transmission to the MME of the Downlink Data Notification message. That is, the downlink data is transmitted to the UE. Otherwise, when the timer is expired, the Downlink Data Notification message is transmitted to the MME.

3) Network Triggered Service Request

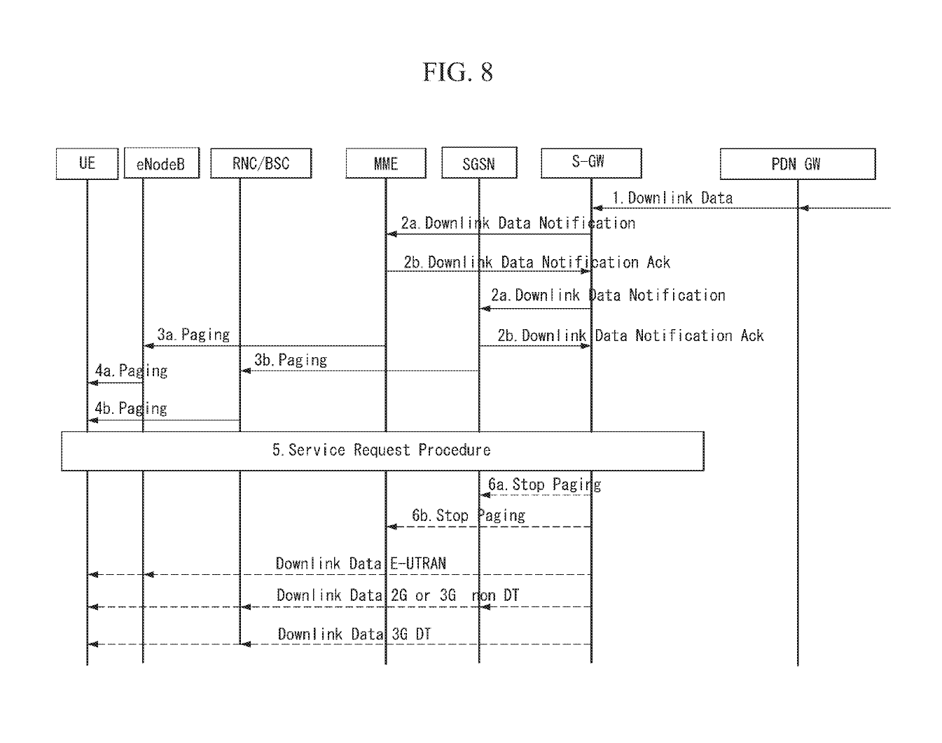

FIG. 8 is a diagram illustrating a network triggered service request procedure in a wireless communication system to which the present invention may be applied.

When the MME needs to signal to the UE in the ECM-IDLE state (e.g., to perform an MME/HSS-initiated detach procedure for the ECM-IDLE UE) or when the S-GW receives control signaling (e.g., a Create Bearer Request or an Update Bearer Request), the MME starts at step 3a of the Network Triggered Service request procedure.

When the ISR is activated, the S-GW receives the Create Bearer Request or the Update Bearer Request for the UE and when the S-GW does not have downlink S1-U and the SGSN notifies to the S-GW that the UE is changed to a PMM-IDLE or STANDBY state, the S-GW buffers the signaling message and transmits the downlink data notification in order to trigger the MME or SGSN for passing the UE. When the S-GW is triggered to transmit a second Downlink Data Notification having a higher propriety (i.e., an ARP priority level) than the already transmitted first Downlink Data Notification while the user plane is waiting to be established, the S-GW transmits a new Downlink Data Notification message indicating a higher priority to the MME. When the S-GW receives an additional downlink signaling message for a bearer having the same or lower priority than the already transmitted first Downlink Data Notification or when the S-GW transmits the second downlink data notification indicating the higher priority and receives the additional downlink signaling message for the UE, the S-GW buffers the downlink signaling messages and does not transmit a new Downlink Data Notification. The S-GW does not notify a current RAT type based on the UE triggered service request procedure. The S-GW performs a dedicated bearer activation or dedicated bearer modification procedure. That is, S-GW transmits the buffered signaling to the MME or SGSN at which the UE is located at present and compares the current RAT type with the last reported RAT type, the S-GW informs the P-GW of the current RAT type. When the dynamic PCC is used, current RAT type information is delivered from the P-GW to the PCRF. When the PCRF response derives EPS bearer modification, the P-GW initiates a bearer update procedure.

When the S-GW transmits Downlink Data Notification, the S-GW makes an EPS Bearer Identifier (ID) and an ARP be included. When the Downlink Data Notification is triggered by the arrival of a downlink data packet at the S-GW, the S-GW makes the EPS bearer ID and ARP associated with the bearer in which the downlink data packet is received. When the Downlink Data Notification is triggered by the arrival of the control signaling, the S-GW makes the EPS Bearer ID and ARP which exist in the control signaling. When the ARP does not exist in the control signaling, the S-GW makes the ARP in the stored EPS bearer context.

When there is the LIPA PDN connection, the L-GW transmits a first downlink user packet to the S-GW and buffers all other downlink user packets at the time of receiving the downlink data for the UE in the ECM-IDLE state. The S-GW triggers the MME in order to page the UE.

1. When the S-GW receives a downlink data packet/control signaling for the UE in which the user plane is not connected (that is, S-GW context data indicates that is no downlink user plane TEID), the S-GW buffers the downlink data packet and identifies the MME or SGSN that services the UE.

When the MME requests the S-GW to throttle downlink low priority traffic and the downlink data packet is received on a low priority bearer to be throttled, the S-GW drops the downlink data.

When the MME requests the S-GW to delay transmission of the Downlink Data Notification, the S-GW buffers the downlink data and waits until the timer expires before step 2 is performed. When the DL-TEID and eNodeB address for the UE are received before the expiry of the timer, the timer is cancelled and the Network triggered Service Request procedure is finished without executing the steps below. That is, the downlink data is transmitted to the UE.

When the S-GW receives additional downlink data packets/control signaling for the UE before the expiry of the timer, the S-GW does not restart the timer.

2. The S-GW transmits the Downlink Data Notification message to the MME and SGSN nodes having control plane connectivity for the given UE. The Downlink Data Notification includes the ARP, the EPS bearer ID, and a paging policy indication. The ARP and EPS Bearer ID are always set in the Data Notification. The MME and the SGSN respond to the S-GW with a downlink data notification Ack message. When supporting Paging Policy Differentiation, the S-GW indicates in the message the Paging Policy Indication related to the downlink data that triggers the Downlink Data Notification message.

The MME and the SGSN that detect that the UE is in a power saving state (i.e., Power Saving Mode or extended idle mode discontinuous reception (DRX)) and determine not to be accessed by current paging initiates extended buffering. The MME/SGSN derives the expected time before radio bearers are established to the UE. The MME/SGSN indicates DL Buffering Requested to the S-GW in the Downlink Data Notification Ack message and includes a DL Buffering Duration time and optionally includes a DL Buffering Suggested Packet Count. The MME/SGSN stores a new value for the DL Data Buffer Expiration Time in the mobility management (MM) context for the UE based on the DL Buffering Duration time and skips the remaining steps of this procedure. The DL Data Buffer Expiration Time is used for UE using the power saving state and indicates that there are buffered data in the S-GW and indicates that a user plane setup procedure is needed when the UE makes signaling to the network. When the DL Data Buffer Expiration Time has expired, the MME/SGSN considers no DL data to be buffered and no indications of Buffered DL Data Waiting are sent during context transferring at the TAU procedure.

When an “Availability after DDN Failure” monitoring event is configured for the UE in the MME/SGSN, the MME/SGSN does not initiate the extended buffering. Instead, the MME/SGSN sets the Notify-on-available-after-DDN-failure flag to remember transmission of the “Availability after DDN Failure” notification when the UE becomes available. When a “UE Reachability” monitoring event is configured for the UE in the MME/SGSN, the MME/SGSN need not initiate the extended buffering.

The MME/SGSN may use additional information based on a service-level agreement (SLA) with an MTC user for when initiating the extended buffering. For example, the MME/SGSN initiates the extended buffering only for a specific access point name (APN), does not initiate the extended buffering with respect to a specific subscriber, or initiates the extended buffering together with the “Availability after DDN failure” and “UE reachability” monitoring events.

The S-GW that receives the DL Buffering Requested indication in a Downlink Data Notification Ack message stores a new value for the DL Data Buffer Expiration Time based on the DL Buffering Duration time and does not transmit any additional Downlink Data Notification even if subsequent downlink data packets for the UE are received in the S-GW before the DL Data Buffer Expiration Time has expired.

When the S-GW is triggered to transmit a second Downlink Data Notification for a bearer having a higher propriety (i.e., an ARP priority level) than the already transmitted first Downlink Data Notification while the user plane is waiting to be established, the S-GW transmits a new Downlink Data Notification message indicating a higher priority to the MME. When the S-GW receives an additional downlink data packet for a bearer having the same or lower priority than the already transmitted first Downlink Data Notification or when the S-GW transmits the second downlink data notification message indicating the higher priority and receives the additional downlink data packet for the UE, the S-GW buffers the downlink data packet and does not transmit a new Downlink Data Notification.

When the S-GW, while waiting for the user plane to be established, receives the Modify Bearer Request message from MME or SGSN other than the MME/SGSN to which the Downlink Data Notification message is transmitted, the S-GW retransmits the Downlink Data Notification message only to the new MME or SGSN from which the Modify Bearer Request message is received even if the ISR is activated.

When the Tracking Area Update procedure with MME change or the Routing Area Update procedure is in progress when the old MME receives the Downlink Data Notification, the old MME rejects the Downlink Data Notification message with an indication that the Downlink Data Notification message is temporarily rejected.

Similarly, if the Rau procedure or the TAU procedure with SGSN change is in progress when the old SGSN receives the Downlink Data Notification, the old SGSN rejects the Downlink Data Notification message with the indication that the Downlink Data Notification message is temporarily rejected.

Upon reception of the Downlink Data Notification Ack message with an indication that the Downlink Data Notification message is temporarily rejected and if the Downlink Data Notification is triggered by the arrival of the downlink data packets at the S-GW, the S-GW starts a locally configured guard timer, buffers all downlink user packets received by the corresponding UE, and waits for the Modify Bearer Request message. Upon reception of the Modify Bearer Request message, the S-GW retransmits the Downlink Data Notification message only to the new MME or SGSN from which the Modify Bearer Request message is received even if the ISR is activated. Otherwise, the S-GW releases the downlink user packets buffered at expiry of the guard timer or receiving the Delete Session Request message from the MME/SGSN.

Upon reception of the Downlink Data Notification Ack message with the indication that the Downlink Data Notification message is temporarily rejected and if the Downlink Data Notification is triggered by the arrival of the signaling messages at the S-GW, the S-GW may reject the PDN GW initiated EPS bearer request with the same indication that the request is temporarily rejected. Upon reception of a rejection for an EPS bearer P-GW initiated procedure with the indication that the request is temporarily rejected, the P-GW may start the locally configured guard timer. The P-GW may reattempt, up to a pre-configured number of times, when either detecting the UE accesses via a new S-GW or at expiry of the guard timer.

3a. When the UE is registered in the MME and it is determined that the UE is reachable by paging, the MME transmits a paging message to each eNB which belongs to a tracking area(s) in which the UE is registered. The paging message includes an NAS ID for paging, TAI(s), a UE identity based a DRX index, a paging DRX length, a list of CSG IDs for paging, and a Paging Priority indication. Steps 3 and 4 are omitted if the MME already has a signaling connection over the S1-MME towards the UE, but the S1-U tunnel has not yet been established.

If extended idle mode DRX is available for the UE, the MME pages the UE just before the occurrence of the UE's next paging occasion.

The paging priority indication is included only:
if the MME receives a Downlink Data Notification or Create Bearer Request with an ARP priority level associated with a multimedia priority service (MPS) or other priority services,
one paging priority level may be used for multiple ARP priority level values.

During a congestion situation the eNB may prioritise the paging of UEs according to the paging priority indication.

If the MME, while waiting for a UE response to the Paging Request message sent without the paging priority indication, receives the Update Bearer Request, the Create Bearer Request, or the Downlink Data Notification, any of which indicates the ARP priority level associated with MPS or other priority services, the MME transmits another paging message with an appropriate paging priority.

When the MME is configured to support CSG paging optimization in a core network (CN), the MME does not transmit the paging messages to the eNB(s) with CSG cells for the UE which does not have a CSG subscription. When the MME is configured to support the CSG paging optimization in an HeNB Subsystem, the list of CSG IDs for paging is included in the paging message. For the CSG paging optimization, the CSG ID(s) of expired CSG subscriptions and valid CSG subscriptions are both included in the list. If the UE has an emergency bearer service, the MME does not perform the CSG paging optimization.

When the MME supports SIPTO at Local Network and LIPA paging for traffic arriving on the PDN connection with the L-GW function collocated with the (H)eNB, the MME pages only the (H)eNB without transmitting the paging messages to the eNB(s) that does not the specific PDN connection.

Paging strategies may be configured in the MME for different combinations of APN, Paging Policy Indication, and other EPS bearer context information (e.g., a QoS class identifier (QCI)) from the S-GW. APN and EPS bearer context information are identified by an EPS bearer ID received in the Downlink Data Notification. The paging strategies may include:
paging retransmission scheme (e.g. how frequently the paging is repeated or at what time interval the paging is repeated);
determining whether to transmit the paging message to the eNB while a specific MME is in a high load state;
whether to apply sub-area based paging (e.g., first paging in the last known ECGI or TA and retransmission in all registered TA(s)).

If the extended idle mode DRX is available in the UE, the MME may additionally consider a Paging Time Window length for a paging retransmission technique.

The MME and the E-UTRAN may additionally support the paging optimization in order to reduce the signaling load and the network resources used to successfully page the UE by one or more following means:
The MME may implement a specific paging strategy (e.g., the S1 paging message is transmitted to the eNB that services the last UE);
The MME may consider information On Recommended Cells And eNBs provided by the E-UTRAN at transition to ECM-IDLE. The MME may consider a part of the information in order to determine the eNBs to be paged and provide information on recommended cells within the S1 paging message to each of the eNBs;
The E-UTRAN may consider Paging Attempt Count Information provided by the MME at paging.

When implementing such optimizations/strategies, the MME considers a PSM active timer and a DRX interval for the UE.

If the UE Radio Capability for Paging Information is available in the MME, the MME adds the UE Radio Capability for Paging Information in the S1 Paging message and transmits the information to the eNB.

If the Information On Recommended Cells And ENBs For Paging is available in the MME, the MME considers the information to determine the eNB(s) for paging and when paging the eNB, the MME may transparently deliver the information on recommended cells to the eNB.

The MME may include paging attempt count information in the S1AP paging message(s). The paging attempt count information may be the same for all eNBs selected by the MME for paging.

If the MME stores information for Enhanced Coverage, the MME includes the stored information in the paging message for all eNBs selected by the MME for paging.

3b. When the UE is registered in the SGSN, the SGSN transmits the paging message to a Radio Network Controller (RNC)/base station system (BSS).

4a. When the eNB receives the paging message from the MME, the UE is paged by the eNB.

4b. When an RNC/BSS receives the paging message from the SGSN, the UE is paged by the RNC/BSS.

5. When UE is in the ECM-IDLE state, upon reception of a paging indication in E-UTRAN access, the UE initiates the UE triggered Service Request procedure. Alternatively, if the UE may use User Plane CIoT EPS Optimization and a suspended access stratum context is stored in the UE, the UE initiates a Connection Resume procedure. If the MME already has a signaling connection over S1-MME towards the UE but the S1-U tunnel has not yet been established, a messages sequence starts from the step when the MME establishes the bearer(s).

Upon reception of the paging indication in UTRAN or GERAN, a mobile station (MS) responds with respective accesses and the SGSN notifies the S-GW.

The MME and/or SGSN supervises a paging procedure with a timer. If the MME and/or SGSN receive no response from the UE to the Paging Request message, the MME and/or SGSN may repeat the paging according to an applicable paging strategy described in step 2 above.

If the MME and/or SGSN receives no response from the UE after the paging repetition procedure, the MME and/or the SGSN transmits the Downlink Data Notification Reject to notify the S-GW about the paging failure, if paging was triggered by a Downlink Data Notification message, unless the MME or SGSN is aware of an ongoing MM procedure that prevents the response of the UE (i.e., the MME or SGSN received a Context Request message indicating that the UE performs TAU or RAU procedure with another MME or SGSN. If paging was triggered by control signaling from the S-GW and if the MME or SGSN receives no response from the UE after the paging repetition procedure, the MME or SGSN rejects that control signaling. When a Downlink Data Notification Reject message is received, if ISR is not activated, the S-GW deletes the buffered packet(s). If ISR is activated and the S-GW receives Downlink Data Notification Reject message from both SGSN and MME, the S-GW deletes the buffered packet(s) or rejects the control signaling which triggers the Service Request procedure. The S-GW may initiate the P-GW charging pause procedure if the UE is in an ECM IDLE state and the PDN GW has enabled the “PDN charging pause” function.

6a. If ISR is activated and a paging response is received in E-UTRAN access, the S-GW transmits a “Stop Paging” message to the SGSN.

6b. If ISR is activated and the paging response is received in UTRAN or GERAN access, the S-GW transmits a “Stop Paging” message to the MME.

The S-GW transmits downlink data towards the UE via the RAT which performed the Service Request procedure.

For a LIPA PDN connection, after the UE enters a connection mode, the packets buffered in the L-GW are forwarded to the HeNB on the direct path. If the UE enters the connection mode at a different cell other than a cell where the L-GW is colocated, the MME deactivates the LIPA PDN connection. If the network triggered service request fails due to no response from the UE, then MME and/or SGSN may initiate the Dedicated Bearer Deactivation procedure for preserved guaranteed bit rate (GBR) bearers based on operator policy.

Hereinafter, the operation between the UE and the MME in the service request procedure described above will be described in more detail.

1) General

The purpose of the service request procedure is to transfer the EMM mode from EMM-IDLE to EMM-CONNECTED mode. If the UE does not uses EPS services with Control Plane CIoT EPS optimization, this procedure is used to establish the radio and S1 bearers when user data or signaling is to be transmitted. If the UE uses the EPS services with Control Plane CIoT EPS optimization, this procedure may be used for transfer of user data initiated by the UE via the control plane. Another purpose of this procedure is to initiate mobile originated (MO)/mobile terminated (MT) circuit switched (CS) fallback or 1xCS fallback procedures.

This procedure is used when:
the network has downlink signaling pending;
the UE has uplink signaling pending;
the UE or the network has user data pending and the UE is in the EMM-IDLE mode;
the UE is in the EMM-CONNECTED mode and has a NAS signaling connection only; the UE is using the EPS services with Control Plane CIoT EPS optimization, and has user data pending which is to be transmitted via user plane radio bearers;
the UE in the EMM-IDLE or EMM-CONNECTED mode has requested to perform MO/MT CS fallback or 1xCS fallback;
the network has downlink cdma2000 signaling pending;
the UE has uplink cdma2000 signaling pending; or
the UE has to request resources for proximity service (ProSe) direct discovery or Prose direct communication.

The service request procedure is initiated by the UE for the downlink transfer of signaling, cdma2000 signaling or user data in the EMM-IDLE mode, but the trigger is given by the network by means of the paging procedure.

The UE initiates the service request procedure when:

a) the UE in the EMM-IDLE mode receives a paging request with a CN domain indicator set to “packet switched (PS)” from the network;

b) the UE in the EMM-IDLE mode has pending user data to be transmitted;

c) the UE in the EMM-IDLE mode has uplink signaling pending;

d) the UE in the EMM-IDLE or EMM-CONNECTED mode is configured to use CS fallback and has a mobile originating CS fallback request from the upper layer;

e) the UE in the EMM-IDLE mode is configured to use CS fallback and receives a paging request with a CN domain indicator set to “CS”, or the UE in the EMM-CONNECTED mode is configured to use CS fallback and receives a CS SERVICE NOTIFICATION message;

f) the UE in the EMM-IDLE or EMM-CONNECTED mode is configured to use 1xCS fallback and has a mobile originating 1xCS fallback request from the upper layer;

g) the UE in the EMM-CONNECTED mode is configured to use 1xCS fallback and accepts cdma2000 signaling messages containing a 1xCS paging request received over E-UTRAN;

h) the UE in the EMM-IDLE mode has uplink cdma2000 signaling pending to be transmitted over E-UTRAN;

i) the UE in the EMM-IDLE or EMM-CONNECTED mode is configured to use 1xCS fallback, accepts cdma2000® signaling messages containing a 1xCS paging request received over cdma2000 1×RTT, and the network supports dual Rx CS fallback (CSFB) or provide CS fallback registration parameters;

j) the UE in the EMM-IDLE or EMM-CONNECTED mode has uplink cdma2000 signaling pending to be transmitted over cdma2000 1×RTT, and the network supports dual Rx CS fallback (CSFB) or provide CS fallback registration parameters;

k) the UE performs an inter-system change from an S101 mode to an S1 mode and has user data pending;

l) the UE in the EMM-IDLE mode has to request resources for ProSe direct discovery or Prose direct communication; or

m) the UE is in the EMM-CONNECTED mode and has a NAS signaling connection only, is using the EPS services with Control Plane CIoT EPS optimization, and has pending user data to be sent via user plane radio bearers;

If one of the above criteria to initiate the service request procedure is fulfilled, then the service request procedure may only be initiated by the UE when the following conditions are fulfilled:
the EPS update status of the UE is EU1 UPDATED, and the TAI of the current serving cell is included in the TAI list; and
no EMM specific procedure is ongoing.

A service request attempt counter is used to limit the number of service request attempts and no response from the network.

The service request attempt counter is reset when:
an attach or combined attach procedure is successfully completed;
a normal or periodic TAU or a combined TAU procedure is successfully completed; or
a service request procedure to obtain packet services is successfully completed.

2) Service Request Procedure Initiation

Hereinafter, a case where the UE is not using the Control Plane CIoT EPS optimization will be described.

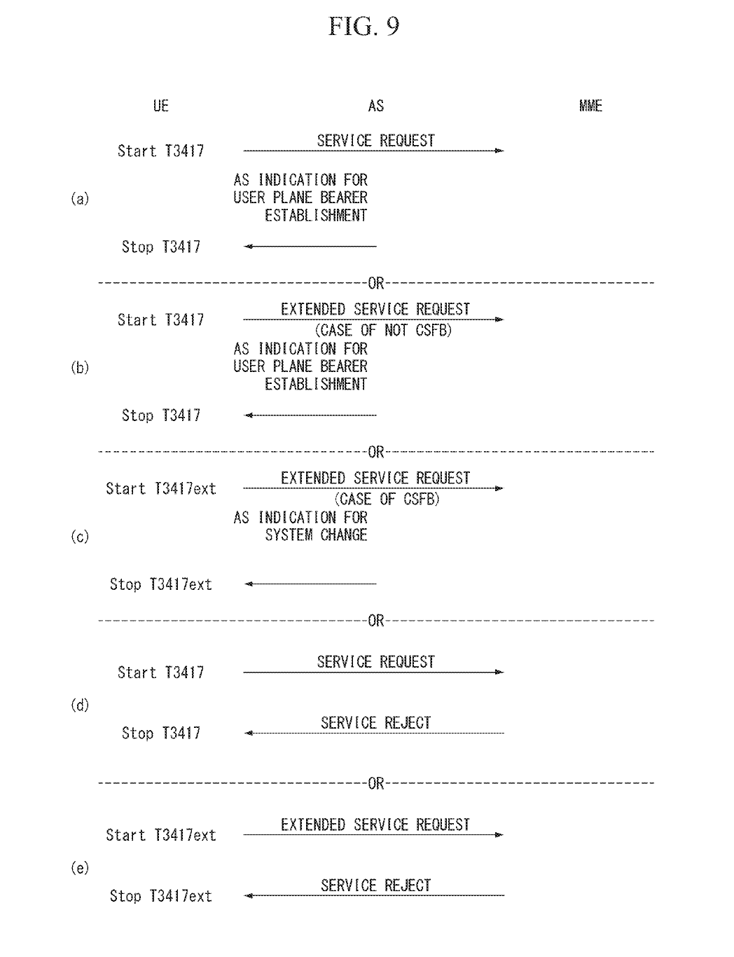

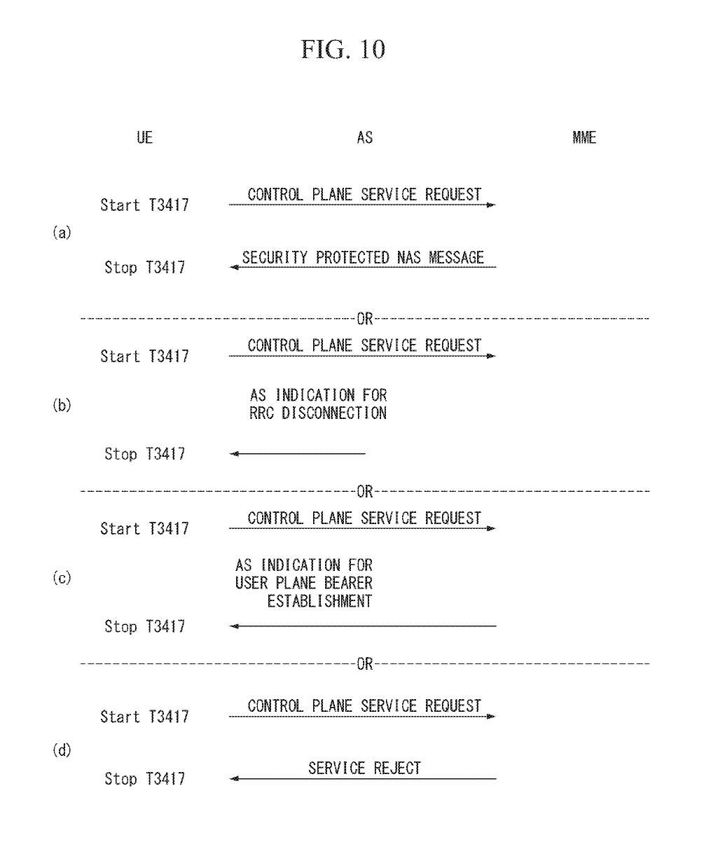

FIGS. 9 and 10 are diagrams illustrating a service request procedure in a wireless communication system to which the present invention may be applied.

In the cases of a), b), c), h), k) and l) described above:
if the UE is not configured for NAS signaling low priority, the UE initiates the service request procedure by transmitting a SERVICE REQUEST message to the MME;
if the UE is not configured for NAS signaling low priority, and the last received ATTACH ACCEPT message or TRACKING AREA UPDATE ACCEPT message from the network indicated that the network supports use of EXTENDED SERVICE REQUEST for packet services, the UE transmits an EXTENDED SERVICE REQUEST message with a service type set to “packet services via S1”; or
if the UE is not configured for NAS signaling low priority, and the last received ATTACH ACCEPT message or TRACKING AREA UPDATE ACCEPT message from the network did not indicate that the network supports use of EXTENDED SERVICE REQUEST for packet services, the UE instead transmits a SERVICE REQUEST message.

In the cases of a), b), c), h), k) and l) described above, after transmitting the SERVICE REQUEST message or the EXTENDED SERVICE REQUEST message with the service type set to “packet services via S1”, the UE starts a T3417 timer and enters the EMM-SERVICE-REQUEST-INITIATED state.

In the case of d) described above, the UE transmits an EXTENDED SERVICE REQUEST message, starts a T3417ext timer, and enters the EMM-SERVICE-REQUEST-INITIATED state.

In the case of e) described above:
if the UE is in the EMM-IDLE mode, the UE transmits an EXTENDED SERVICE REQUEST message, start a T3417ext timer, and enters the EMM-SERVICE-REQUEST-INITIATED state.
if the UE is in the EMM-CONNECTED mode and if the UE accepts the paging, the UE transmits an EXTENDED SERVICE REQUEST message with the CSFB response IE indicating “CS fallback accepted by the UE”, starts T3417ext and enters the EMM-SERVICE-REQUEST-INITIATED state; or
if the UE is in the EMM-CONNECTED mode and if the UE rejects the paging, the UE transmits an EXTENDED SERVICE REQUEST message with the CSFB response IE indicating “CS fallback rejected by the UE” and enters the EMM-REGISTERED.NORMAL-SERVICE state. The network does not initiate CS fallback procedures.

In the case of f, g, i, and j described above, the UE transmits an EXTENDED SERVICE REQUEST message, starts a T3417 timer, and enters the EMM-SERVICE-REQUEST-INITIATED state.

One-to-One ProSe Direct Communication

1) General

One-to-one ProSe direct communication is realized by establishing a secure layer-2 link over PC5 between two UEs.

Each UE has a Layer-2 ID for unicast communication. The Layer-2 ID is included in the source Layer-2 ID field of every frame transmitted on the layer-2 link and included in a destination Layer-2 ID of every frame received on the layer-2 link.

The UE needs to ensure that the Layer-2 ID for unicast communication is at least locally unique. To that effect, the UE should be prepared to handle Layer-2 ID conflicts with adjacent UEs using unspecified mechanisms (e.g., self-assign a new Layer-2 ID for unicast communication when the conflict is detected).

The layer-2 link for one-to-one ProSe direct communication is identified by the combination of the Layer-2 IDs of the two UEs. This means that the UE can engage in multiple layer-2 links for one-to-one ProSe direct communication using the same Layer-2 ID.

2) Establishment of Secure Layer-2 Link Over PC5

FIG. 11 illustrates a procedure of establishing a secure layer-2 link over a PC5 interface in the wireless communication system to which the present invention may be applied.

UEs engaged in isolated (that is, non-relay) one-to-one communication negotiate internet protocol (IP) address allocation mechanisms and optionally exchange link-local IP version 6 (IPv6) addresses if needed during the link establishment procedure.

1. UE-1 sends a Direct Communication Request message to UE-2 in order to trigger mutual authentication. This message includes the User Info.

If the link is setup for isolated one-to-one communication (i.e., none of the UEs is a relay), UE-1 indicates, to UE-2, in the message whether to act as a Dynamic Host Configuration Protocol version 4 (DHCPv4) server, an IPv6 router, or both. If UE-1 does not support any of the IP address allocation mechanisms, UE-1 includes a link-local IPv6 address in the message.

2. UE-2 initiates the procedure for mutual authentication. The successful completion of the authentication procedure completes the establishment of the secure layer-2 link (i.e., establishment of secure association) over PC5. As a part of this step, UE-2 includes the User Info in a response to UE-1.

If the link is setup for isolated one-to-one communication (i.e., none of the UEs is a relay), UE-2 indicates to UE-1 in the response message whether to act as a DHCPv4 server, an IPv6 router, or both. If UE-2 does not support any of the IP address allocation mechanisms and UE-1 included a link-local IPv6 address in step 1, UE-2 includes a non-conflicting link-local IPv6 address in the response message.

If both UE-1 and UE-2 selected to use link-local IPv6 address, the both UE-1 and UE-2 may not use the duplicate address detection defined in RFC4862.

3) Layer-2 Link Maintenance Over PC5

The PC5 signaling protocol supports keep-alive functionality that is used to detect that when the UEs are not in a ProSe communication range. This is to proceed with implicit layer-2 link release.

4) Layer-2 Link Release Over PC5

FIG. 12 illustrates a procedure of releasing the layer-2 link via a PC5 interface in the wireless communication system to which the present invention may be applied.

This procedure is used to release the layer-2 link between the remote UE and the UE-to-Network relay, and initiated by either the remote UE or the relay (e.g., due to temporary loss of connectivity to the network, battery running low of the relay, etc.).

1. UE-1 transmits a Disconnect Request message to UE-2 in order to release the layer-2 link and delete all associated context data.

2. Upon reception of the Disconnect Request message, UE-2 responds with a Disconnect Response message and deletes all context data associated with the layer-2 link.

UE Capability Handling

1) General

The UE capability information is configured of UE Radio Capability information and the UE Core Network Capability information.

The UE Radio Capability information for Paging is separate from both the UE Radio Capability information and the UE Core Network Capability information. The UE Radio Capability information for Paging may be used to enhance the paging in the E-UTRAN.

2) UE Radio Capability Handling

The UE Radio Capability information contains information on RAT(s) supported by the UE (e.g., power class, frequency bands, etc). Consequently, this information is sufficiently large which is undesirable to be transmitted over the radio interface at every transition from ECM-IDLE to ECM-CONNECTED. To avoid this radio overhead, the MME stores the UE Capability information during the ECM-IDLE state, and if it is available, the MME transmits the last UE Radio Capability information to the E-UTRAN in the S1 interface INITIAL CONTEXT SETUP REQUEST message unless the UE is performing an Attach procedure or a TAU procedure for the “first TAU following GERAN/UTRAN Attach” or for a “UE radio capability update”.

If the UE is performing the Attach procedure or the TAU procedure for the “first TAU following GERAN/UTRAN Attach” or for “UE radio capability update”, the MME deletes any UE Radio Capability information that has been stored. If the MME transmits an S1 interface INITIAL CONTEXT SETUP REQUEST or UE RADIO CAPABILITY MATCH REQUEST message during this procedure, the MME does not transmit any UE Radio Capability information to the E-UTRAN in the message. This triggers the E-UTRAN to request the UE Radio Capability to the UE and to upload the UE Radio Capability to the MME in the S1 interface UE CAPABILITY INFO INDICATION message. The MME stores the UE Radio Capability information, and include it in the INITIAL CONTEXT SETUP REQUEST or UE RADIO CAPABILITY MATCH REQUEST messages, in other cases than Attach procedure or the TAU procedure for the “first TAU following GERAN/UTRAN Attach” and “UE radio capability update” procedure.

If the UE is performing a Service Request or other procedures and the MME does not have UE Radio Capability information available, the MME transmits an S1 interface INITIAL CONTEXT SETUP REQUEST message to the E-UTRAN without any UE Radio Capability information. This triggers the E-UTRAN to request the UE Radio Capability to the UE and upload the UE Radio Capability to the MME in the S1 interface UE CAPABILITY INFO INDICATION message.

For the EPS CIoT Optimizations, during the Attach procedure or the TAU procedure (e.g., for the “first TAU following GERAN/UTRAN Attach”), if the MME does not transmit an S1 interface INITIAL CONTEXT SETUP REQUEST to the E-UTRAN, the MME should obtain the UE Radio Capability information by transmitting the Connection Establishment Indication message without UE Radio Capability information included to the E-UTRAN. This triggers the E-UTRAN to request the UE Radio Capability to the UE and upload the UE Radio Capability to the MME in the S1 interface UE CAPABILITY INFO INDICATION message. In subsequent ECM connections, if the MME does not transmit an S1 interface INITIAL CONTEXT SETUP REQUEST to the E-UTRAN, the MME transmits the UE Radio Capability information to the E-UTRAN in a Connection Establishment Indication message or Downlink NAS Transport message.

The UE Radio Capability is not provided directly from one CN node to another node. It is uploaded to the MME when the E-UTRAN requests the UE Radio Capability information to the UE.

During handover via the MME (both intra RAT and inter RAT), the radio capability information between the source and target 3GPP RATs are transferred in the “source to target transparent container”. Information on additional 3GPP RATs is optionally transferred in the “source to target transparent container”. The transfer of the radio capability information related to the source and/or additional RATs is effective to avoid the need for the target RAT to acquire the information from the UE prior to a subsequent inter-RAT handover.

Owing to issues with dynamic UTRAN security parameters, special rules apply to the handling of the UTRAN radio capability information at inter-RAT handover.

To reflect future radio technologies, frequency bands, and other enhancements, the MME stores the UE Radio Capability Information.

The E-UTRAN stores the S1 interface INITIAL CONTEXT SETUP REQUEST message or the UE Radio Capability information obtained from the UE, during the RRC connection for the corresponding UE. Before any handover attempt from E-UTRAN to UTRAN, the E-UTRAN obtains the UE's UTRAN Radio Capabilities from the UE.

If the UE's non-UTRAN UE Radio Capability information is changed in the ECM-IDLE state (including cases of being in GERAN/UTRAN coverage), the UE performs a TAU indicating “UE radio capability update” when returning to E-UTRAN coverage.

The MME may also request Voice Support Match Information. If requested, the eNB then derives and provides an indication to the MME whether the UE radio capabilities are compatible with the network configuration (e.g., whether the UE supports the frequency bands for providing “full” PS voice coverage or whether the UE supports a single radio voice call continuity (SRVCC) configuration of the network).

3) UE Core Network Capability

The UE Core Network Capability is divided into the UE Network Capability IE (mostly for E-UTRAN access related core network parameters) and the MS Network Capability IE (mostly for UTRAN/GERAN access related core network parameters) and contains non radio-related capabilities (e.g. the NAS security algorithms etc.). Both the UE Network Capability and the MS Network Capability are transferred between CN nodes (MME to MME, MME to SGSN, SGSN to SGSN, and SGSN to MME).

In order to ensure that the UE Core Network Capability information stored in the MME is up to date (e.g., to control the situation when the universal subscriber identity module (USIM) is moved into a different device while out of coverage, and the previous device does not transmit the Detach message; and the cases of inter-RAT TAU), the UE transmits the UE Core Network Capability information to the MME during the Attach and non-periodic TAU procedure within the NAS message.

The MME always stores the latest UE Core Network Capability received from the UE. Any UE Core Network Capability that an MME receives from a previous MME/SGSN is replaced when the UE provides the UE Core Network Capability with Attach and the TAU signaling. If MS Network Capability is not included in Attach or non-periodic TAU signaling (e.g., UE can access only the E-UTRAN), the MME removes the stored MS Network Capability, and if the UE's UE Core Network Capability information is changed (located in the GERAN/UTRAN coverage and ISR activated), the UE performs a TAU (‘type’ different to ‘periodic’) when the UE returns to E-UTRAN coverage.

Hereinafter, the UE network capability will be described in more detail.

The purpose of the UE network capability IE is to provide the network with information concerning aspects of the UE related to EPS or interworking with GPRS. The contents in the IE may affect the manner in which the network controls the operation of the UE. The UE network capability IE indicates general UE characteristics and therefore, except for fields explicitly indicated, is independent of the frequency band of the channel to which the IE is transmitted.

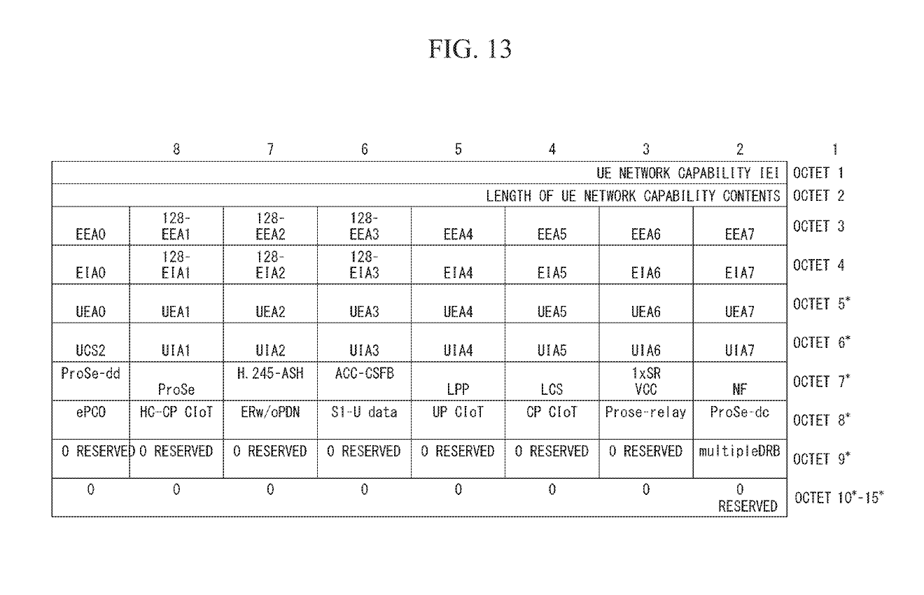

FIG. 13 is a diagram illustrating a UE network capability information element in the wireless communication system to which the present invention may be applied.

The UE network capability IE is coded as shown in FIG. 13 and Table 2.

The UE network capability IE is a type 4 IE with a minimum length of 4 octets and a maximum length of 15 octets.

TABLE 2
EPS encryption algorithms supported (octet 3)
EPS encryption algorithm EEA0 supported (octet 3, bit 8)

| | |
|---|---|
| 0 | EPS encryption algorithm EEA0 not supported |
| 1 | EPS encryption algorithm EEA0 supported |

EPS encryption algorithm 128-EEA1 supported (octet 3, bit 7)

| | |
|---|---|
| 0 | EPS encryption algorithm 128-EEA1 not supported |
| 1 | EPS encryption algorithm 128-EEA1 supported |

EPS encryption algorithm 128-EEA2 supported (octet 3, bit 6)

| | |
|---|---|
| 0 | EPS encryption algorithm 128-EEA2 not supported |
| 1 | EPS encryption algorithm 128-EEA2 supported |

EPS encryption algorithm 128-EEA3 supported (octet 3, bit 5)

| | |
|---|---|
| 0 | EPS encryption algorithm 128-EEA3 not supported |
| 1 | EPS encryption algorithm 128-EEA3 supported |

EPS encryption algorithm EEA4 supported (octet 3, bit 4)

| | |
|---|---|
| 0 | EPS encryption algorithm EEA4 not supported |
| 1 | EPS encryption algorithm EEA4 supported |

EPS encryption algorithm EEA5 supported (octet 3, bit 3)

| | |
|---|---|
| 0 | EPS encryption algorithm EEA5 not supported |
| 1 | EPS encryption algorithm EEA5 supported |

EPS encryption algorithm EEA6 supported (octet 3, bit 2)

| | |
|---|---|
| 0 | EPS encryption algorithm EEA6 not supported |
| 1 | EPS encryption algorithm EEA6 supported |

EPS encryption algorithm EEA7 supported (octet 3, bit 1)

| | |
|---|---|
| 0 | EPS encryption algorithm EEA7 not supported |
| 1 | EPS encryption algorithm EEA7 supported |

EPS integrity algorithms supported (octet 4)
EPS integrity algorithm EIA0 supported (octet 4, bit 8)

| | |
|---|---|
| 0 | EPS integrity algorithm EIA0 not supported |
| 1 | EPS integrity algorithm EIA0 supported |

EPS integrity algorithm 128-EIA1 supported (octet 4, bit 7)

| | |
|---|---|
| 0 | EPS integrity algorithm 128-EIA1 not supported |
| 1 | EPS integrity algorithm 128-EIA1 supported |

EPS integrity algorithm 128-EIA2 supported (octet 4, bit 6)

| | |
|---|---|
| 0 | EPS integrity algorithm 128-EIA2 not supported |
| 1 | EPS integrity algorithm 128-EIA2 supported |

EPS integrity algorithm 128-EIA3 supported (octet 4, bit 5)

| | |
|---|---|
| 0 | EPS integrity algorithm 128-EIA3 not supported |
| 1 | EPS integrity algorithm 128-EIA3 supported |

EPS integrity algorithm EIA4 supported (octet 4, bit 4)

| | |
|---|---|
| 0 | EPS integrity algorithm EIA4 not supported |
| 1 | EPS integrity algorithm EIA4 supported |

EPS integrity algorithm EIA5 supported (octet 4, bit 3)

| | |
|---|---|
| 0 | EPS integrity algorithm EIA5 not supported |
| 1 | EPS integrity algorithm EIA5 supported |

EPS integrity algorithm EIA6 supported (octet 4, bit 2)

| | |
|---|---|
| 0 | EPS integrity algorithm EIA6 not supported |
| 1 | EPS integrity algorithm EIA6 supported |

EPS integrity algorithm EIA7 supported (octet 4, bit 1)

| | |
|---|---|
| 0 | EPS integrity algorithm EIA7 not supported |
| 1 | EPS integrity algorithm EIA7 supported |

UMTS encryption algorithms supported (octet 5)
UMTS encryption algorithm UEA0 supported (octet 5, bit 8)

| | |
|---|---|
| 0 | UMTS encryption algorithm UEA0 not supported |
| 1 | UMTS encryption algorithm UEA0 supported |

UMTS encryption algorithm UEA1 supported (octet 5, bit 7)

| | |
|---|---|
| 0 | UMTS encryption algorithm UEA1 not supported |
| 1 | UMTS encryption algorithm UEA1 supported |

UMTS encryption algorithm UEA2 supported (octet 5, bit 6)

| | |
|---|---|
| 0 | UMTS encryption algorithm UEA2 not supported |
| 1 | UMTS encryption algorithm UEA2 supported |

UMTS encryption algorithm UEA3 supported (octet 5, bit 5)

| | |
|---|---|
| 0 | UMTS encryption algorithm UEA3 not supported |
| 1 | UMTS encryption algorithm UEA3 supported |

UMTS encryption algorithm UEA4 supported (octet 5, bit 4)

| | |
|---|---|
| 0 | UMTS encryption algorithm UEA4 not supported |
| 1 | UMTS encryption algorithm UEA4 supported |

UMTS encryption algorithm UEA5 supported (octet 5, bit 3)

| | |
|---|---|
| 0 | UMTS encryption algorithm UEA5 not supported |
| 1 | UMTS encryption algorithm UEA5 supported |

UMTS encryption algorithm UEA6 supported (octet 5, bit 2)

| | |
|---|---|
| 0 | UMTS encryption algorithm UEA6 not supported |
| 1 | UMTS encryption algorithm UEA6 supported |

UMTS encryption algorithm UEA7 supported (octet 5, bit 1)

| | |
|---|---|
| 0 | UMTS encryption algorithm UEA7 not supported |
| 1 | UMTS encryption algorithm UEA7 supported |

UCS2 support (UCS2) (octet 6, bit 8)
This information field indicates the treatment of UCS2 encoded
character strings by the UE.

| | |
|---|---|
| 0 | The UE has a preference for the default alphabet over UCS2. |
| 1 | The UE has no preference between the use of the default |
| | alphabet and the use of UCS2. |

UMTS integrity algorithms supported (octet 6)
UMTS integrity algorithm UIA1 supported (octet 6, bit 7)

| | |
|---|---|
| 0 | UMTS integrity algorithm UIA1 not supported |
| 1 | UMTS integrity algorithm UIA1 supported |

UMTS integrity algorithm UIA2 supported (octet 6, bit 6)

| | |
|---|---|
| 0 | UMTS integrity algorithm UIA2 not supported |
| 1 | UMTS integrity algorithm UIA2 supported |

UMTS integrity algorithm UIA3 supported (octet 6, bit 5)

| | |
|---|---|
| 0 | UMTS integrity algorithm UIA3 not supported |
| 1 | UMTS integrity algorithm UIA3 supported |

UMTS integrity algorithm UIA4 supported (octet 6, bit 4)

| | |
|---|---|
| 0 | UMTS integrity algorithm UIA4 not supported |
| 1 | UMTS integrity algorithm UIA4 supported |

UMTS integrity algorithm UIA5 supported (octet 6, bit 3)

| | |
|---|---|
| 0 | UMTS integrity algorithm UIA5 not supported |
| 1 | UMTS integrity algorithm UIA5 supported |

UMTS integrity algorithm UIA6 supported (octet 6, bit 2)

| | |
|---|---|
| 0 | UMTS integrity algorithm UIA6 not supported |
| 1 | UMTS integrity algorithm UIA6 supported |

UMTS integrity algorithm UIA7 supported (octet 6, bit 1)

| | |
|---|---|
| 0 | UMTS integrity algorithm UIA7 not supported |
| 1 | UMTS integrity algorithm UIA7 supported |

NF capability (octet 7, bit 1)

| | |
|---|---|
| 0 | notification procedure not supported |
| 1 | notification procedure supported |

1xSRVCC capability (octet 7, bit 2)

| | |
|---|---|
| 0 | SRVCC from E-UTRAN to cdma2000 1× CS not supported |
| 1 | SRVCC from E-UTRAN to cdma2000 1× CS supported |

Location services (LCS) notification mechanisms capability (octet 7, bit 3)

| | |
|---|---|
| 0 | LCS notification mechanisms not supported |
| 1 | LCS notification mechanisms supported |

LTE Positioning Protocol (LPP) capability (octet 7, bit 4)

| | |
|---|---|
| 0 | LPP not supported |
| 1 | LPP supported |

Access class control for CSFB (ACC-CSFB) capability (octet 7, bit 5)

| | |
|---|---|
| 0 | eNodeB-based access class control for CSFB not supported |
| 1 | eNodeB-based access class control for CSFB supported |

H.245 After SRVCC Handover capability (H.245-ASH) (octet 7, bit 6)
This bit indicates the H.245 support capacity and use of pre-defined
codecs, and if needed, H.245 codec negotiation after SRVCC handover.

| | |
|---|---|
| 0 | H.245 capacity after SRVCC handover not supported |
| 1 | H.245 capability after SRVCC handover supported |

ProSe (octet 7, bit 7)
This bit indicates the capability for ProSe.

| | |
|---|---|
| 0 | ProSe not supported |
| 1 | ProSe supported |

ProSe direct discovery (ProSe-dd) (octet 7, bit 8)
This bit indicates the capability for ProSe direct discovery.

| | |
|---|---|
| 0 | ProSe direct discovery not supported |
| 1 | ProSe direct discovery supported |

ProSe direct communication (ProSe-dc) (octet 8, bit 1)
This bit indicates the capability for ProSe direct communication.

| | |
|---|---|
| 0 | ProSe direct communication not supported |
| 1 | ProSe direct communication supported |

ProSe UE-to-network-relay (ProSe-relay) (octet 8, bit 2)
This bit indicates the capability to act as a ProSe UE-to-network relay

| | |
|---|---|
| 0 | Acting as ProSe UE-to-network relay not supported |
| 1 | Acting as ProSe UE-to-network relay supported |

Control plane CIoT EPS optimization (CP CIoT) (octet 8, bit 3)
This bit indicates the capability for control plane CIoT EPS
optimization.

| | |
|---|---|
| 0 | Control plane CIoT EPS optimization not supported |
| 1 | Control plane CIoT EPS optimization supported |

User plane CIoT EPS optimization (UP CIoT) (octet 8, bit 4)
This bit indicates the capability for user plane CIoT EPS optimization.

| | |
|---|---|
| 0 | User plane CIoT EPS optimization not supported |
| 1 | User plane CIoT EPS optimization supported |

S1-u data transfer (S1-U data) (octet 8, bit 5)
This bit indicates the capability for S1-u data transfer.

| | |
|---|---|
| 0 | S1-U data transfer not supported |
| 1 | S1-U data transfer supported |

EMM-REGISTERED without PDN connection (ERw/oPDN)
(octet 8, bit 6)
This bit indicates the capability for EMM REGISTERED without PDN
connection.

| | |
|---|---|
| 0 | EMM-REGISTERED without PDN connection not |
| | supported |
| 1 | EMM-REGISTERED without PDN connection supported |

Header compression for control plane CIoT EPS optimization (HC-CP
CIoT) (octet 8, bit 7)
This bit indicates the capability for header compression for control
plane CIoT EPS optimization.

| | |
|---|---|
| 0 | Header compression for control plane CIoT EPS |
| | optimization not supported |
| 1 | Header compression for control plane CIoT EPS |
| | optimization supported |

Extended protocol configuration options (ePCO) (octet 8, bit 8)
This bit indicates the support of the extended protocol configuration
options IE.

| | |
|---|---|
| 0 | Extended protocol configuration options IE not supported |
| 1 | Extended protocol configuration options IE supported |

Multiple DRB support (multipleDRB) (octet 9, bit 1)
This bit indicates the capability to support multiple user plane radio
bearers in NB-S1 mode.

| | |
|---|---|
| 0 | Multiple DRB not supported |
| 1 | Multiple DRB supported |

All other bits in octet 10 to 15 are spare and coded as zero.

4) UE Radio Capability for Paging Information

The purpose of the procedure is to assist the E-UTRAN in optimizing the radio paging procedure.

The eNB uploads the UE radio capability information for paging to the MME within the S1 interface UE CAPABILITY INFO INDICATION message (within a separate IE from the UE radio capability). The UE radio capability for paging includes UE radio paging information provided to the eNB by the UE and includes other information (e.g., band support information) derived from the UE radio capability information by the eNB.

In general, the radio paging procedure is performed simultaneously when the eNB uploads the UE radio capability information. The MME stores UE radio capability information for paging in the MME context. When the MME needs to perform paging, the MME provides the UE radio capability information for paging to the eNB as a part of the S1 paging message. The eNB may use the UE radio capability information for paging to enhance paging towards the UE.

When the UE radio capability information for paging is changed, the UE follows the same procedure as when the UE radio capability is changed.

The UE radio capability information for paging as a part of MM Context information is transmitted to the target MME in order to control a situation in which the UE radio capability information is changed between the MMEs in the connected mode. The UE radio capability information for paging may be applied only to the MME, but is not applied to the SGSN. Therefore, the information is not included by the MME when the context is delivered to the SGSN.

Initial Context Setup

1) General

The purpose of the initial context setup procedure is to establish all required initial UE contexts including an E-UTRAN Radio Access Bearer (E-RAB) context, a Security Key, a Handover Restriction List, a UE Radio capability, and UE Security Capabilities). The procedure adopts UE-associated signaling.

2) Successful Operation

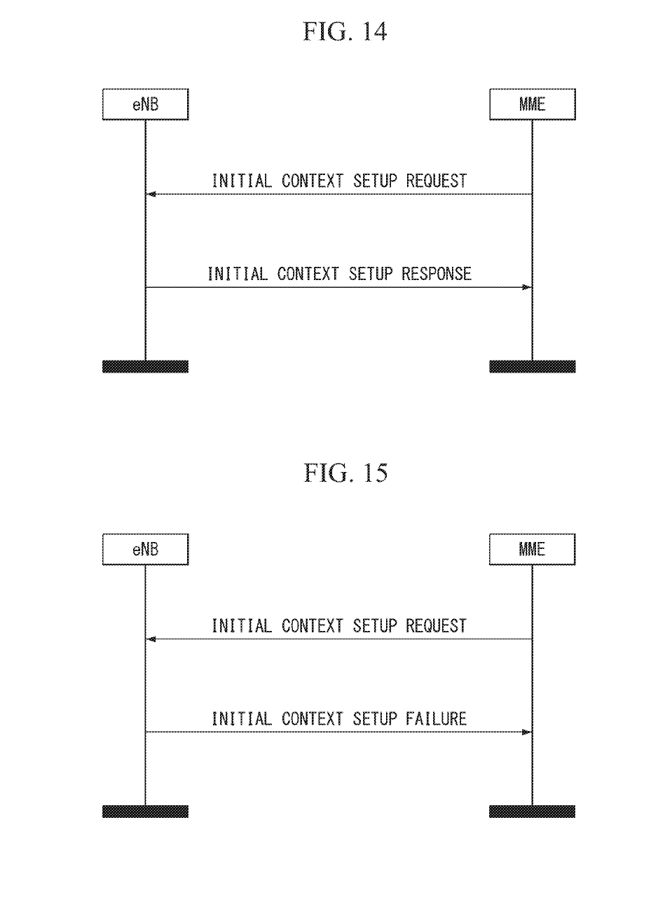

FIG. 14 illustrates an initial context setup procedure in a wireless communication system to which the present invention may be applied.

The eNB receives an INITIAL CONTEXT SETUP REQUEST from the MME.

The eNB transmits an INITIAL CONTEXT SETUP RESPONSE message to the MME in response to the INITIAL CONTEXT SETUP REQUEST.

Table 3 shows the INITIAL CONTEXT SETUP REQUEST message. The message is transmitted by the MME in order to request set-up of the UE context.

TABLE 3

| IE/Group | | | IE type and | Semantics | | Assigned |
|---|---|---|---|---|---|---|
| Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate | M | | 9.2.1.20 | | YES | reject |
| Maximum Bit | | | | | | |
| Rate | | | | | | |
| E-RAB to Be | | 1 | | | YES | reject |
| Setup List | | | | | | |
| >E-RAB to Be | | 1 . . . | | | EACH | reject |
| Setup Item IEs | | <maxnoofE- | | | | |
| | | RABs> | | | | |
| >>E-RAB ID | M | | 9.2.1.2 | | — | |
| >>E-RAB | M | | 9.2.1.15 | Includes | — | |
| Level QoS | | | | necessary QoS | | |
| Parameters | | | | parameters. | | |
| >>Transport | M | | 9.2.2.1 | | — | |
| Layer Address | | | | | | |
| >>GTP-TEID | M | | 9.2.2.2 | | — | |
| >>NAS-PDU | O | | 9.2.3.5 | | — | |
| >>Correlation | O | | 9.2.1.80 | | YES | ignore |
| ID | | | | | | |
| >>SIPTO | O | | Correlation ID | | YES | ignore |
| Correlation ID | | | 9.2.1.80 | | | |
| >>Bearer Type | O | | 9.2.1.116 | | YES | reject |
| UE Security | M | | 9.2.1.40 | | YES | reject |
| Capabilities | | | | | | |
| Security Key | M | | 9.2.1.41 | The KeNB is | YES | reject |
| | | | | provided after | | |
| | | | | the key-generation | | |
| | | | | in the MME, see | | |
| | | | | TS 33.401 [15]. | | |
| Trace | O | | 9.2.1.4 | | YES | ignore |
| Activation | | | | | | |
| Handover | O | | 9.2.1.22 | | YES | ignore |
| Restriction | | | | | | |
| List | | | | | | |
| UE Radio | O | | 9.2.1.27 | | YES | ignore |
| Capability | | | | | | |
| Subscriber | O | | 9.2.1.39 | | YES | ignore |
| Profile ID for | | | | | | |
| RAT/Frequency | | | | | | |
| priority | | | | | | |
| CS Fallback | O | | 9.2.3.21 | | YES | reject |
| Indicator | | | | | | |
| SRVCC | O | | 9.2.1.58 | | YES | ignore |
| Operation | | | | | | |
| Possible | | | | | | |
| CSG | O | | 9.2.1.73 | | YES | ignore |
| Membership | | | | | | |
| Status | | | | | | |
| Registered | O | | 9.2.3.1 | | YES | ignore |
| LAI | | | | | | |
| GUMMEI | O | | 9.2.3.9 | This IE | YES | ignore |
| | | | | indicates the | | |
| | | | | MME serving | | |
| | | | | the UE. | | |
| MME UE | O | | 9.2.3.3 | This IE | YES | ignore |
| S1AP ID 2 | | | | indicates the | | |
| | | | | MME UE S1AP ID | | |
| | | | | assigned by | | |
| | | | | the MME. | | |
| Management | O | | 9.2.1.83 | | YES | ignore |
| Based MDT | | | | | | |
| Allowed | | | | | | |
| Management | O | | MDT PLMN List | | YES | ignore |
| Based MDT | | | 9.2.1.89 | | | |
| PLMN List | | | | | | |
| Additional CS | C-ifCSF | | 9.2.3.37 | | YES | ignore |
| Fallback | Bhigh | | | | | |
| Indicator | priority | | | | | |
| Masked | O | | 9.2.3.38 | | YES | ignore |
| IMEISV | | | | | | |
| Expected UE | O | | 9.2.1.96 | | YES | ignore |
| Behaviour | | | | | | |
| ProSe | O | | 9.2.1.99 | | YES | ignore |
| Authorized | | | | | | |
| UE User Plane | O | | 9.2.1.113 | | YES | ignore |
| CIoT Support | | | | | | |
| Indicator | | | | | | |
| V2X Services | O | | 9.2.1.120 | | YES | ignore |
| Authorized | | | | | | |
| UE Sidelink | O | | 9.2.1.122 | This IE applies | YES | ignore |
| Aggregate | | | | only if the UE is | | |
| Maximum | | | | authorized for | | |
| Bit Rate | | | | V2X services. | | |
| Enhanced | O | | 9.2.1.123 | | YES | ignore |
| Coverage | | | | | | |
| Restricted | | | | | | |

Referring to Table 3, the IE/Group Name represents the name of an information element (IE) or an information element group (IE group). ‘M’ in a Presence field as a mandatory represents an IE/IE group included in the message, and ‘0’ as an optional IE represents an IE/IE group that may be included in the message or not included in the message, and ‘C’ represents as a conditional IE represents an IE/IE group included in the message only when a specific condition is satisfied. A Range field indicates the number of repetitive IEs/IE groups which may be repeated.

An IE type and reference field indicates a type (e.g., ENUMERATED data, INTEGER, OCTET STRING, etc.) of the corresponding IE and indicates a range of a value when the range of a value which the corresponding IE may have exists.

A Criticality field indicates criticality information applied to the IE/IE group. The criticality information refers to information indicating how a receiver should operate in the case where the receiver does not understand the entirety or a part of the IE/IE group. indicates that the criticality information is not applied and ‘YES’ indicates that the criticality information is applied. ‘GLOBAL’ indicates that there is one criticality information common to the IE and repetition of the corresponding IE. ‘EACH’ indicates that there is unique criticality information for each repetition of the IE. An Assigned Criticality field indicates actual criticality information.

With respect to the detailed description of the IE shown in Table 3, the 3GPP TS 36.413 v14.3.0 document is incorporated by reference herein.

For E-RAB establishment, the EPC should be prepared to receive user data before the INITIAL CONTEXT SETUP RESPONSE message is received from the MME. If there is no UE-associated logical S1-connection, a UE-associated logical S1-connection should be established upon receipt of the INITIAL CONTEXT SETUP REQUEST message.

The INITIAL CONTEXT SETUP REQUEST message includes information required by the eNB to establish a new E-RAB configuration that includes at least one additional E-RAB in the E-RAB to List Setup List IE to be set up.

The E-RAB to List Setup List IE to be set up may include the following:
NAS-PDU IE,
   In case of the LIPA operation, Correlation ID,
In case of the SIPTO@LN operation, SIPTO Correlation ID,
Bearer Type IE.

The INITIAL CONTEXT SETUP REQUEST message may include the following:
Trace Activation IE.
   Handover Restriction List IE, which may include a roaming or access restriction.
   UE Radio Capability IE.
   Subscriber Profile ID for RAT/Frequency priority IE.
   CS Fallback Indicator IE.
SRVCC Operation Possible IE.
   CSG Membership Status IE.
   Registered location area identity (LAI) IE
   Globally Unique MME Identifier (GUMMEI) IE, which indicates the MME serving the UE.
   MME UE S1AP ID 2 IE, which indicates MME UE S1AP ID allocated by the MME.
Management based minimization of drive-tests (MDT) allowed IE.
   Management Based MDT PLMN List IE.
   Additional CS Fallback Indicator IE.
   Masked International Mobile Equipment Identity Software Version (IMEISV) IE.
   Expected UE Behaviour IE.
   ProSe Authorized IE.
   UE User Plane CIoT Support Indicator IE.
   Vehicle-to-Everything (V2X) Services Authorized IE.
   UE Sidelink Aggregate Maximum Bit Rate IE.

The INITIAL CONTEXT SETUP REQUEST message may include a Subscriber Profile ID for RAT/Frequency priority IE if available in the MME.

If the Correlation ID IE is included in the INITIAL CONTEXT SETUP REQUEST message toward the eNB with the L-GW function for LIPA operation, the eNB uses the information for the LIPA operation for the associated E-RAB.

If the SIPTO Correlation ID IE is included in the INITIAL CONTEXT SETUP REQUEST message toward the eNB with the L-GW function for the SIPTO@LN operation, the eNB uses the information for the v operation for the associated E-RAB.

When a Bearer Type IE is included in the INITIAL CONTEXT SETUP REQUEST and is set to “non IP’, the eNB does not perform header compression for the associated E-RAB.

When the Masked IMEISV IE is included in the INITIAL CONTEXT SETUP REQUEST, the target eNB uses the Masked IMEISV IE in order to determine a feature of the UE for subsequent control.

When the Expected UE Behaviour IE is included in the INITIAL CONTEXT SETUP REQUEST message, the eNB may store the information and use the information in order to determine an RRC connection time.

Upon receiving the INITIAL CONTEXT SETUP REQUEST, the eNB performs the following:
Attempting to execute a requested E-RAB configuration.
Storing UE Aggregate Maximum Bit Rate in the UE context and uses the received UE Aggregate Maximum Bit Rate for a non-GBR bearer for the corresponding UE.
Passing values included in an NAS-PDU IE and an E-RAB ID IE for each established data bearer to a radio interface protocol. The eNB does not transmit an NAS PDU associated with an unsuccessful data radio bearer to the UE.
stores the received Handover Restriction List in the UE context.
stores the received UE Radio Capability in the UE context.
stores the received Subscriber Profile ID for RAT/Frequency priority in the UE context.
stores the received SRVCC Operation Possible in the UE context.
stores the received UE Security Capabilities in the UE context.
stores the received Security Key in the UE context.
stores the received CSG Membership Status in the UE context.
stores the received Management Based MDT Allowed information in the UE context.
stores the received Management Based MDT PLMN List information in the UE context.
stores the received Security Key information in the UE context.
stores the received V2X Services Authorization information in the UE context.
stores the received UE Sidelink Aggregate Maximum Bit Rate in the UE context and uses the stored UE Sidelink Aggregate Maximum Bit Rate for sidelink communication of the associated UE in a network scheduling mode for the V2X service.
stores an initial value for a Next Hop Chaining Count in the UE context for the initial context setup.

Allocation of a resource according to a value of the Allocation and Retention Priority IE is used as a rule described in the E-RAB setup procedure.

3) Unsuccessful Operation

FIG. 15 illustrates an initial context setup procedure in a wireless communication system to which the present invention may be applied.

The eNB receives an INITIAL CONTEXT SETUP REQUEST from the MME.

The eNB transmits an INITIAL CONTEXT SETUP FAILURE message to the MME in response to the INITIAL CONTEXT SETUP REQUEST.

When the eNB may not establish the S1 UE context, or when the eNB may not also establish one GBR bearer, the eNB regards the procedure as failed and responds with the INITIAL CONTEXT SETUP FAILURE message.

Layer 2 Relay Signaling Procedure

Relays defined in 3GPP Rel-10 and relays (e.g., relay UE) in proximity based service (ProSe) of Rel-12 and Rel-13 as a layer 3 relay have the following characteristics from the viewpoint of radio layers (or interfaces).

The relay UE may perform processing (e.g., user data regeneration processing or user data transmission processing) on the traffic of remote UE. The processing may include ciphering for retransmitting user data at a radio interface and user-data concatenation/segmentation/reassembly and then, may include an encoding/modulation process for transmission to the base station (e.g., an eNB or a base station).

The characteristics of the layer 3 relay in terms of the network layer are as follows.
The relay UE may serve as an Internet protocol (IP) router. To this end, the relay UE may participate in IP setting (e.g., allocating the IP address) for the remote UE. In this case, in the network (for example, EPS), the IP address allocated to the remote UE is recognized as the IP address allocated to the relay UE and the remote UE is not recognized as an individual UE. Such a basic operation may be also confirmed in a UE-to-network relay operation in Rel-12 and Rel-13 ProSe and the contents are as follows.

In Rel-12 and Rel-13 ProSe, the Relay UE establishes a separate PDN connection for the remote UE and recognizes a mapping relationship between the IP address allocated to the PDN connection and the IP address allocated to the remote UE. In this way, when the Relay UE receives data from the remote UE, the Relay UE checks the IP address included in a header of the data, and routes the data to appropriate PDN connection and transmits the corresponding data. Data reception in a DL direction is also performed in the same manner as described above. When the Relay UE receives the data from a network (e.g., the eNB or the base station), the Relay UE checks the IP address included in the header of the data, checks the appropriate Remote UE, and transmits the data to the remote UE through a configured direct link. In this case, the relay UE adds and transmits a link layer address of the remote UE for transmission to the corresponding remote UE through the direct link.

In 3GPP, a new study is in progress for wearable devices. Even in this study, it is basically assumed that the remote UE (e.g., the wearable device or the UE) communicates with the network via the relay UE. However, unlike the Rel-10 Relay or the relays of Rel-12 and Rel-13 ProSe, a layer 2 relay is assumed. The Layer 2 relay has the following differences from the layer 3 relay described above.

When a layer 2 relay method is used, the relay UE may be referred to as an enhanced relay UE (eRelay-UE) and the remote UE may be referred to as an enhanced remote UE (eRemote-UE).

That is, the eRelay-UE refers to a layer 2 relay that supports indirect 3GPP communication between the eRemote-UE and the 3GPP network using E-UTRA, WLAN, or Bluetooth between the eRemote-UE and the relay.

In addition, the eRemote-UE refers to a UE connected to the network using the indirect 3GPP communication.

In addition, the indirect 3GPP communication refers to signaling and communication between the UE and the 3GPP network in which the eRelay-UE exists between the eRemote-UE and the 3GPP network.

A) The relay UE may process the traffic of the remote UE, and

B) the relay UE does not serve as the IP router.

Due to the characteristics of A) above, when the relay UE receives data or signaling for the remote UE, the relay UE may process the data or signaling. In addition, due to the characteristics of B) above, the relay UE does not participate in the IP configuration (for example, allocating the IP address) for the remote UE and the relay UE does not perform handling (e.g., IP router role: checking and routing the IP address) of an IP layer of data of the remote UE allocated from the remote UE or the network.

Therefore, the remote UE needs to use the IP address allocated from the network. This means that when the remote UE configures the direct link with the relay UE through a PC5 interface and transmits/receives the data/signaling through the configuration, the remote UE needs to use the IP address allocated by the network. The remote UE uses the IP address allocated by the network means that the network has the context of the remote UE and recognizes the remote UE.

In such an environment, the remote UE needs to perform individual signaling with the network. In this case, the individual means that the relay UE and the remote UE are distinguished from each other in the communication with the network.

The signaling (e.g., the RRC procedure or NAS procedure) between the UE and the network is defined/designed for the signaling between one UE and the network. Therefore, the signaling scheme in the related art may not be suitable for individual signaling between the relay UE and the remote UE in a situation where the relay UE and the remote UE configure the direct link. This will be described with reference to the following drawing.

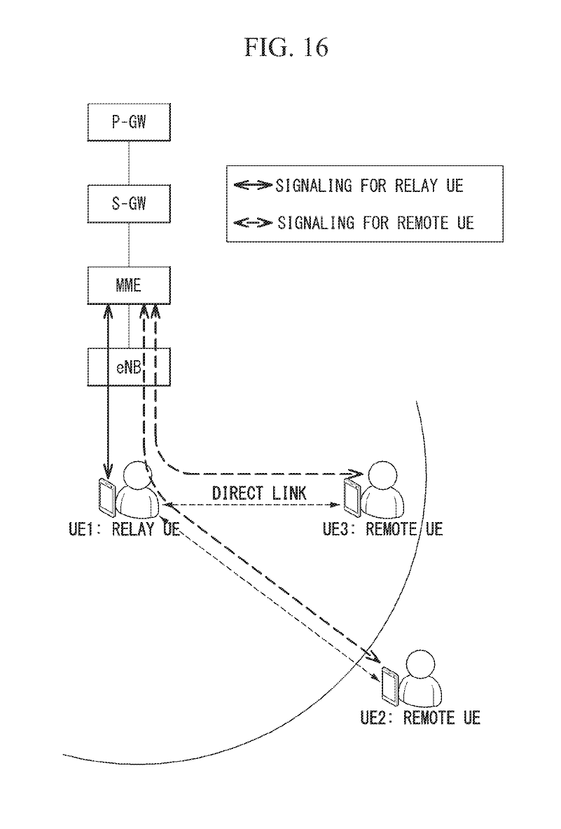

FIG. 16 is a diagram illustrating a layer-2 relay operation in a wireless communication system to which the present invention may be applied.

In FIG. 16, it is illustrated a state in which UE 1 operates as the relay UE, UE 2 and UE 3 operate as the remote UEs, and UE 1 establishes the direct link with each of UE 2 and UE 3.

The relay UE may be in-coverage, while the remote UE may be in-coverage or out-of-coverage.

In FIG. 16, UE 1 is located in in-coverage, UE 2 is located in-coverage, and UE 3 is located in out-of-coverage.

When the relay UE is the layer 2 relay, the remote UE (i.e., UE 2 or UE 3) needs to configure the direct link with the relay UE and then, perform each of the individual signaling with the network.

The relay UE performs the signaling procedure (e.g., the RRC procedure and/or NAS procedure) thereof with the network (e.g., the eNB and/or MME). Further, the remote UE performs the signaling procedure (e.g., the RRC procedure and/or NAS procedure) thereof with the network (e.g., the eNB and/or MME). In this case, the signaling message of the remote UE is delivered to the network through the relay UE and the relay UE does not perform processing (e.g., reading or modifying) for the signaling message.

In addition, PC5 signaling of a direct link section for supporting the individual signaling of the relay UE and the remote UE is required.

Additionally, in the ProSe in the related art, a Relay Service Code is considered as one of conditions for selecting/discovering the relay UE. The remote UE may confirm a connectivity service provided by the relay UE through the relay service code. The relay service code is described below. In this regard, a 3GPP TS 24.334 v13.4.0 document is incorporated herein by reference.
The Relay Service Code parameter identifies the connectivity service provided by the UE-to-Network relay. The value of the Relay Service Code parameter is a bit string having a length of 24 bits. A format of the relay service code parameter is outside the scope of this specification.

Here, the connectivity service may refer to a specific organization (for example, a police station) or a specific service. In this case, an organization may be distinguished according to each country, each region, and each detailed organization and a service may represent a service supporting a specific application. In other words, the connectivity service indicates whether the relay UE may access (be connected to) the corresponding organization or application (server). This is not related to a physical or functional capability of the relay UE.

However, in the case of the layer 2 relay considered in the present invention, the remote UE needs to perform a service (e.g., Voice over LTE (VoLTE), CIoT, eDRX, etc.) requiring various capabilities or functionalities which the remote UE directly performs with the network even in a form to be connected with the relay UE. To this end, the remote UE needs to select/discover the relay UE having a capability to support a desired service.

However, there is currently no method to support the selection/discovery. That is, when the remote UE is connected to the relay UE and the relay UE transmits/receives the traffic of the remote UE instead, the communication of the remote UE is dependent on the capability of the relay UE, not the capability thereof.

In order to solve the problem, the present invention proposes a signaling procedure (i.e., RRC signaling and/or NAS signaling procedure) with a network suitable for a layer 2 relay environment and PC5 signaling for supporting the signaling procedure.

Hereinafter, in the following description of the present invention, the present invention is described by exemplifying one remote UE and one relay UE for convenience of description, but a connection between one relay UE and multiple remote UEs may be provided and even in this case, the present invention to be described below may be similarly applied.

### First Embodiment) Checking and Selecting Capability of Relay UE and Capability Handling in Network

As pointed out above as the problem, when the remote UE is connected to the relay UE and the relay UE transmits/receives the traffic of the remote UE to/from the network instead, the communication of the remote UE is dependent on the capability of the relay UE, not the capability thereof.

The present invention proposes a method for performing communication by checking the capability of the relay UE by the remote UE and a method for recognizing and performing a relationship of the relay UE when performing an operation related with the capability of the remote UE in the network.

In the present invention, the capability may include all of a UE-to-network capability, a radio capability, a capability (e.g., eDRX or PSM) to support a specific functionality, and the like.

[1] Method for Checking Capability of Relay UE and Selecting Relay UE

The capability of the relay UE may be delivered to the remote UE by one scheme of two following schemes. This will be described with reference to the drawing.

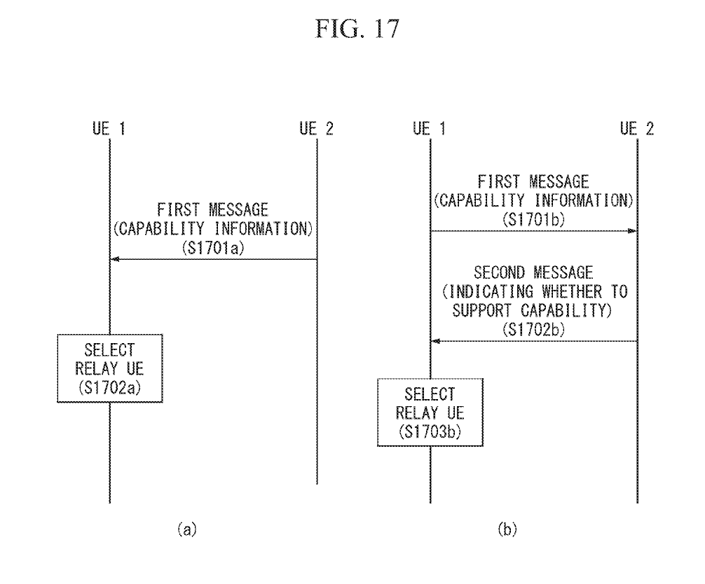

FIG. 17 is a diagram illustrating a method for exchanging capability information between a remote UE and a relay UE according to an embodiment of the present invention.

In FIG. 17, UE 1 is exemplified as a UE which operates (or is desired to operate) as the remote UE and UE 2 is exemplified as a UE which operates (or is desired to operate or is operable) as the relay UE. In FIG. 17, UE 2 is illustrated as one UE for convenience of description, but UE 2 may correspond to a plurality of UEs.

FIG. 17(a) illustrates a method in which when the relay UE notifies the capability which the relay UE supports/has, the remote UE recognizes the capability.

Referring to FIG. 17(a), UE 2 transmits a first message including capability information thereof to UE 1 (S1701a).

For example, the relay UE (i.e., a UE operable as the relay UE) may broadcast a message including a capability which the relay UE supports/has.

In addition, the remote UE may know the capability of a UE neighboring thereto through the broadcasted message.

When UE 1 confirms/recognizes the capabilities of the neighboring UEs, UE 1 may select a relay UE that supports the capability desired thereby (S1702a).

FIG. 17(b) illustrates a method in which when the capability of the remote UE is announced, the relay UE announces whether to support the corresponding capability and the remote UE recognizes whether to support the corresponding capability.

Referring to FIG. 17(b), UE 1 transmits a first message including capability information thereof to UE 1 (S1701b).

For example, the remote UE may broadcast a message including the capability thereof.

In this case, when the capability of the remote UE is announced, all capabilities which the remote UE supports/has may be announced and only a capability of required for a service desired by the remote UE may be selected and announced. As described above, when the capability is selectively announced, there is an effect that signaling overhead may be reduced.

Upon receiving the first message from UE 1, UE 2 responds with a second message including an indication as to whether to support the corresponding capability (S1702b).

The remote UE may know a UE that supports the capability by receiving a message as to whether to support the corresponding capability from the neighboring UE.

When UE 1 confirms/recognizes the capabilities of the neighboring UEs, UE 1 may select a relay UE that supports the capability desired thereby (S1703b).

In this case, when a process of confirming the capability of the relay UE described in FIG. 17 is performed in the discovery procedure, the process may be implemented through a PC5 discovery message.

Further, when the process of confirming the capability of the Relay UE is performed within a process of establishing a one-to-one connection, the process may be implemented through a PC5 signaling protocol (e.g., a direct link setup request/response).

In addition, besides, a new protocol or message may be used in the process of confirming the capability of the relay UE.

Through the above process, when the remote UE selects the relay UE, the relay UE may separately notify the network of the capability of the relay UE and the capability of the remote UE when informing the network of the capability.

In this case, when the network recognizes the relationship between the remote UE and the relay UE, the capability of the remote UE may be regarded as the capability of the relay UE.

[2] Radio Capability Handling in Network

UE radio capability information means radio capability information which the UE may support for each RAT. For example, the UE radio capability information may include information (e.g., a power class, a frequency band, etc.) on RAT supported by the UE.

When the UE radio capability information is stored in the MME and the UE radio capability information is included in the INITIAL CONTEXT SETUP REQUEST message and transmitted to the eNB in the process of being switched from EMM-IDLE to EMM-CONNECTED.

The eNB may use the UE radio capability information for radio related operations (e.g., power control, resource allocation, modulation, etc.).

Further, besides, in addition to the INITIAL CONTEXT SETUP REQUEST message, the UE radio capability may also be delivered from the MME to the eNB.

When the remote UE is connected to the relay UE and the relay UE transmits/receives the traffic of the remote UE to/from the network instead, the communication of the remote UE is dependent on the capability of the relay UE, not the capability thereof. Therefore, in this case, when the eNB intends to deliver the traffic of the remote UE through the relay UE, the eNB needs to use the radio capability of the relay UE, not the radio capability of the remote UE.

This will be described with reference to the following drawing.

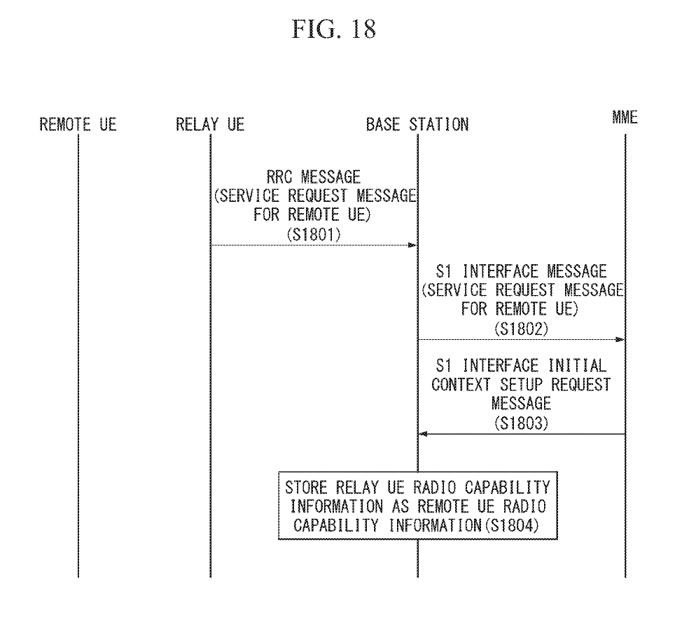

FIG. 18 is a diagram schematically illustrating a service request procedure according to an embodiment of the present invention.

In FIG. 18, a service request procedure proposed by the present invention to be described below may be performed.

Referring to FIG. 18, the relay UE transmits an RRC message encapsulated with a Service Request message for the remote UE, which includes an identifier of the remote UE to the base station (S1801).

A condition for triggering the Service Request procedure will be described below in more detail.

The base station transmits the Service Request message to the MME in the S1 interface message (S1802).

The base station receives the INITIAL CONTEXT SETUP REQUEST message from the MME (S1803).

As described above, the radio capability may be delivered through the INITIAL CONTEXT SETUP REQUEST message.

However, when the remote UE is connected to the relay UE and the relay UE transmits/receives the traffic of the remote UE to/from the network instead, the MME of the remote UE may transmit the INITIAL CONTEXT SETUP REQUEST message not including the UE radio capability of the remote UE.

Alternatively, even when the remote UE is connected to the relay UE and the relay UE transmits/receives the traffic of the remote UE to/from the network instead, the MME of the remote UE may transmit the INITIAL CONTEXT SETUP REQUEST message including the UE radio capability of the relay UE.

Alternatively, even when the remote UE is connected to the relay UE and the relay UE transmits/receives the traffic of the remote UE to/from the network instead, the MME of the remote UE may transmit the INITIAL CONTEXT SETUP REQUEST message including the UE radio capability of the remote UE.

The base station stores the UE radio capability information of the relay UE as UE radio capability information of the remote UE (S1804).

In other words, when the above-described case occurs, the base station may perform transmission and reception by applying not the capability of the remote UE but the capability of the relay UE (in spite of receiving the capability of the remote UE) even to transmission and reception of the DRUB of the remote UE (e.g., power control, resource allocation, modulation, etc.).

In this case, the base station needs to recognize that the relay UE is connected to the remote UE so that the relay UE transmits/receives the traffic of the remote UE to/from the network instead (i.e., the relationship between the relay UE and the remote UE). Therefore, the MME makes an indication indicating an indication that the relay UE is connected to the remote UE and the relay UE transmits/receives the traffic of the remote UE to/from the network instead (i.e., the corresponding S1AP message is for the remote UE) or a UE identifier (i.e., a relay UE identifier and/or remote UE identifier) be included in the S1AP message (e.g., INITIAL CONTEXT SETUP REQUEST message, etc.) to notify the base station of the relationship between the relay UE and the remote UE.

In addition, when the relay UE and the remote UE are connected to each other and the relay UE transmits/receives the traffic of the remote UE to/from the network instead, if the base station does not have the radio capability of the remote UE, the base station recognizes the relationship between the relay UE and the remote UE and if there is the radio capability of the relay UE, the radio capability of the relay UE is used to store the radio capability of the relay UE and transmit the traffic of the remote UE and if there is no capability of the relay UE, the base station may request the radio capability of the relay UE to the relay UE or the MME of the relay UE. In this case, the requested procedure/message may be delivered/performed according to the related art or through a new procedure.

Hereinafter, although not illustrated in FIG. 18, the base station may store the radio capability information of the relay UE and perform a radio bearer setup procedure for the relay UE and the remote UE based on the stored radio capability information. For example, the base station may transmit an RRC Connection Reconfiguration message for modifying the RRC connection to the relay UE and receive transmits an RRC Connection Reconfiguration Complete message for confirming successful completion of the RRC connection reconfiguration from the relay UE.

Here, the RRC Connection Reconfiguration message is a command for modifying the RRC connection. The message may carry related dedicated NAS information and information for a measurement configuration, a mobility control, radio resource configuration (including radio bearer(s), a MAC main configuration, and a physical channel configuration), including a security configuration. The RRC Connection Reconfiguration Complete message is a message used for confirming successful completion of the RRC connection configuration.

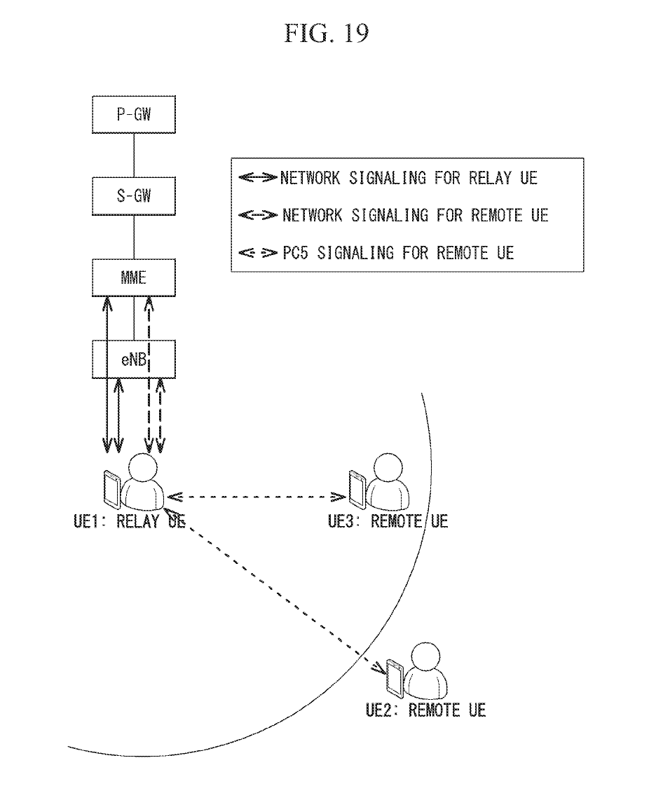

FIG. 19 is a diagram illustrating a signaling flow of a layer-2 relay in a wireless communication system to which the present invention may be applied.

In FIG. 19, it is illustrated a state in which UE 1 operates as the relay UE, UE 2 and UE 3 operate as the remote UEs, and UE 1 establishes the direct link with each of UE 2 and UE 3.

The relay UE may be in-coverage, while the remote UE may be in-coverage or out-of-coverage.

Referring to a Uu interface (i.e., a radio interface between the UE and the base station) section, the relay UE separately transmits and receives signaling thereof and signaling for the remote UE.

Further, referring to a PC5 interface (i.e., a radio interface between the UE and the UE) section, the remote UE transmits signaling toward the network through a direct link (i.e., a sidelink) or the relay UE transmits the signaling from the network to the remote UE.

### Second Embodiment) Individual Network Signaling in Uu Interface Section

In an embodiment of the present invention, first, a method for individual network signaling between the remote UE and the relay UE is proposed.

In this case, the network signaling may include RRC signaling and/or NAS signaling.

[1] Service Request Procedure for Layer 2 Relay

First, the Service Request procedure is proposed in the NAS signaling.

Referring back to FIG. 7 (i.e., the Service Request procedure in the related art), when the UE transmits the SERVICE REQUEST message to the network, the MME that receives the transmitted SERVICE REQUEST message transmits a UE context in the INITIAL CONTEXT SETUP REQUEST message and a bearer context of the corresponding UE to the eNB. The ENB that receives the contexts establishes a data radio bearer corresponding to the context through a radio bearer establishment process based on the bearer context.

The layer 2 relay needs to configure the bearer of the remote UE in addition to the bearer thereof.

Such a configuration may be performed through the NAS procedure and two methods including a method for establishing the DRB for one or more UEs (i.e., the relay UE and the remote UE) at the time of performing one Service Request procedure [1-2] and a method for individually performing the Service Request procedure [1-3] are proposed. The detailed description thereof will be made later.

1. The NAS procedure may be the Service Request procedure in the related art.

In this case, the NAS message which the relay UE transmits to perform the Service Request procedure may be the SERVICE REQUEST message, an EXTENDED SERVICE REQUEST message, or a CONTROL PLANE SERVICE REQUEST message in the related art.

Further, the NAS message which the relay UE transmits to perform the Service Request procedure may be a newly defined NAS message.

2. The NAS procedure may be a newly defined NAS procedure.

3. Before performing the NAS procedure, the following situations may be satisfied.

A. The relay UE and the remote UE have the direct link established.

B. The relay UE may be in an EMM-IDLE mode or EMM-CONNECTED mode.

In this case, when the relay UE is in the EMM-IDLE mode, either the UE of the relay UE or the remote UE may be in a state where the DRB is not established.

Alternatively, when the relay UE is in the EMM-CONNECTED mode, only one UE of the relay UE and the remote UE may be in the state where the DRB is not established.

[1-1] Method for Recognizing Relationship Between Two UEs in Network

In the network, the relationship between the relay UE and the remote UE needs to be recognized. That is, it is possible to perform optimized handling by recognizing the relationship of two UEs (i.e., Relay UE and Remote UE) in the network (e.g., MME).

A method for recognizing the relationship of two UEs in the network (e.g., MME) is as follows.

The relay UE may use the following method in order to recognize the relationship of two UEs in the network (e.g., MME).

1. Pre-Condition: A Method for Recognizing the Relationship Between the Relay UE and the Remote UE by the Network

1) Method of Using Remote UE Report Procedure

This method may be implemented through the remote UE report procedure in the related art. The relay UE may inform the network whether the remote UE is directly connected or disconnected through such a procedure and the network may recognize the relationship between both UEs.

2) Method of Using Another Signaling Procedure

A. Method for informing through RRC message and S1-AP message: The relay UE may inform the eNB of whether the remote UE is connected to or disconnected from the direct link by using the RRC message and the eNB may inform the MME of whether the remote UE is connected to or disconnected from the direct link by using the S1-AP message.

In this case, the RRC message and the S1-AP message may be messages in the related art or newly defined messages.

B. Method for informing through NAS message: The relay UE may inform the MME of whether the remote UE is connected to or disconnected from the direct link by using the NAS message.

In this case, the NAS message may be an NAS message (e.g., SERVICE REQUEST, EXTENDED SERVICE REQUEST, CONTROL PLANE SERVICE REQUEST, or TAU REQUEST) in the related art or a newly defined NAS message.

C. In terms A and B, the relay UE may include a new identity instead of an indication for indicating whether the remote UE in the message is connected or disconnected from the direct link or the identifier of the remote UE or the identifier of the relay UE.

In this case, the identifier (e.g., IMSI or International Mobile Equipment Identity (IMEI)) of the remote UE may be acquired by the relay UE through a PC5 procedure (e.g., a direct discovery procedure, a direct communication procedure, or a PC5 signaling) in the related art. In order to acquire the identifier of the remote UE, such as GUTI or S-TMSI, the PC5 procedure in the related art may be updated or a new PC5 message may be required.

Further, when a new identifier is included instead of the identifier of the existing relay UE, the new identifier may be an identifier allocated for the relay UE and the remote UE in the network. The new identifier may be a temporary identifier (e.g., GUTI) allocated by the network for both UEs or may be a pre-configuration identifier (e.g., a group identifier).

3) By method 1) or 2) described above, the network may recognize the relationship between the relay UE and the remote UE. In this case, it may be recognized that specific signaling transmitted by the relay UE includes the remote UE in addition to the relay UE itself.

[1-2] Method for Establishing DRB for One or More UEs (i.e., Relay UE and Remote UE) when Performing One Service Request Procedure

A method for establishing the DRB for one or more UEs (i.e., relay UE and remote UE) when performing the Service Request procedure may be used. In this method, it may be assumed that the relationship between both UEs is recognized in the network and this method may be performed as follows.

1. Triggering Condition for Service Request Procedure

A triggering condition under which the relay UE performs the Service Request procedure is as follows.
The Service Request procedure of the relay UE may be triggered when the relay UE is switched from EMM-IDLE to EMM-CONNECTED.

Here, a case where the relay UE needs to be switched from EMM-IDLE to EMM-CONNECTED includes all following cases.

A. If the triggering condition (see the condition that the Service Request procedure described above is initiated/triggered) of the Relay UE's own Service Request procedure is satisfied,

Among the triggering conditions of the relay UE's own service request, a case where the relay UE receives the paging message in the EMM-IDLE mode also includes the following cases.
A case where the relay UE receives the paging message therefor
A case where the relay UE receives the paging message for the remote UE
A case of receiving the paging message jointly for the relay UE and the remote UE

In this case, the paging message jointly for the relay UE and the remote UE may include a group identifier for both UEs.

B. If the relay UE recognizes that the remote UE needs to transmit (or desires to transmit) signaling or data to the network when the relay UE is in the EMM-IDLE mode: A recognition method is as follows.
A case where the remote UE transmits the corresponding signaling or data to the relay UE through the PC5 interface
A case where the remote UE sends to the relay UE an indication or message that ‘there is signal or data to be transmitted to the network’ through the PC5 interface

2. Performing Service Request Procedure

When the relay UE performs the Service Request procedure, the bearer of the remote UE may also be established in addition to the bearer of the relay UE.

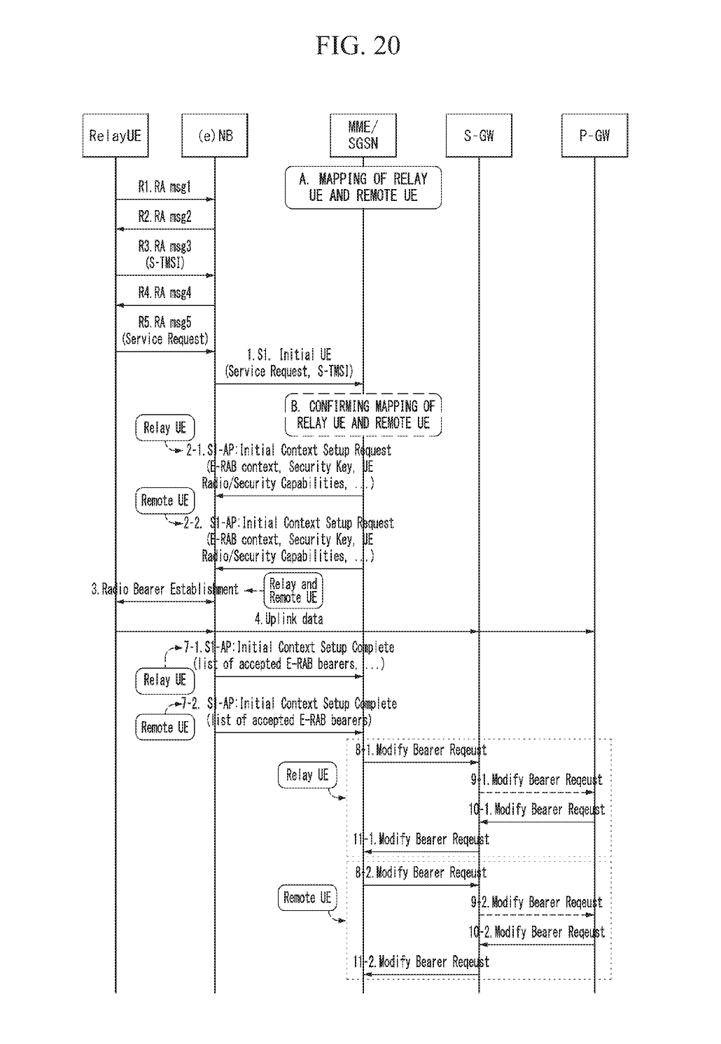

FIG. 20 is a diagram illustrating a service request procedure according to an embodiment of the present invention.

The description of FIG. 7 may be incorporated into the description of FIG. 20 as long as the description of FIG. 20 does not clearly contradict the description of FIG. 7 previously described above.

A. It is assumed that the MME/SGSN knows the mapping relationship between the Relay UE and the Remote UE.

R 1 to R 4 denote the random access procedure described in FIG. 6 above. In addition, the relay UE transmits R5. random access (RA) message 5 encapsulated with the SERVICE REQUEST message to the (e)NB.

Here, since performing one Service Request procedure for the relay UE and the remote UE is assumed, it is assumed that the RRC signaling (i.e., R1 to R5) of a radio section is transmitted from the relay UE to the eNB only once.

1. The (e)NB transmits an S1 initial UE message to the MME/SGSN.

In this case, the S1 initial UE message may include the SERVICE REQUEST message and S-TMSI of the relay UE (and/or remote UE).

Here, since performing one Service Request procedure for the relay UE and the remote UE is assumed, the initial UE message is transmitted from the eNB to the MME/SGSN only once.

B. Upon receiving the SERVICE REQUEST message, the MME/SGSN confirms the mapping relationship between the relay UE and the remote UE.

a. When receiving the Service Request message from the Relay UE, the network confirms the relationship between both UEs (step B in the following figure) and performs the initial context setup request (step 2-1 and step 2-2 in the following figure).

If the network (i.e., MME/SGSN) recognizes that the Service Request procedure is for the Remote UE as well as the Relay UE, the signaling between the network entities (i.e., eNB, MME, S-GW, and P-GW) may be performed.

Here, the signaling may be the existing signaling message (e.g., INITIAL UE message, INITIAL CONTEXT SETUP REQUEST/RESPONSE message, and MODIFY BEARER REQUEST/RESPONSE message) or a newly defined signaling message.

2-1, 2-2. When the MME/SGSN confirms the relationship between both UEs, the MME/SGSN transmits to the eNB the INITIAL CONTEXT SETUP REQUEST message which is the S1-AP message.

In this case, the INITIAL CONTEXT SETUP REQUEST message may include information such as an E-RAB context, a security key, a UE radio/security capability, etc. (see Table 3 above).

3. The (e)NB performs the radio bearer establishment procedure with the relay UE.

In this case, the bearer of the remote UE may also be established in addition to the bearer of the relay UE.

4. Uplink data may be delivered to the S-GW from the UE by the eNB.

7-1, 7-2. The eNB transmits the INITIAL CONTEXT SETUP COMPLETE message which is the S1-AP message to the MME.

In this case, the INITIAL CONTEXT SETUP REQUEST may include a list of accepted E-RAB bearers, etc.

8-1, 8-2. The MME/SGSN transmits the MODIFY BEARER REQUEST message to the S-GW for each PDN connection.

9-1, 9-2. The S-GW transmits the MODIFY BEARER REQUEST message to the P-GW for each PDN connection.

10-1, 10-2. The P-GW transmits the MODIFY BEARER RESPONSE message to the S-GW.

11-1, 11-2. The S-GW transmits the MODIFY BEARER RESPONSE message to the MME/SGSN.

Here, in steps 2, 7, 8, 9, 10, and 11 above, the INITIAL CONTEXT SETUP REQUEST message, the INITIAL CONTEXT SETUP COMPLETE message, the MODIFY BEARER REQUEST message, and the MODIFY BEARER RESPONSE message may be transmitted to each of the relay UE and the remote UE as shown in the example of FIG. 20 or transmitted at one time (i.e., one message) in order to reduce signaling overhead.

When each is transmitted, a first message may be a message for the relay UE and a second message may be a message for the remote UE, or vice versa.

Further, when each is transmitted, the network entity that transmits the message may make an indication that a subsequent message is transmitted be included in the first message for efficient signaling in the network entity that receives the message. Therefore, the network entity that receives the first message may perform a next operation after receiving the second message without immediately performing a subsequent operation.

For example, when the MME/SGSN confirms the relationship between both UEs in step B above, the MME/SGSN transmits to the eNB the INITIAL CONTEXT SETUP REQUEST message which is the S1-AP message for the remote UE in addition to the relay UE. In this case, in step 2-1, when the MME/SGSN transmits the INITIAL CONTEXT SETUP REQUEST message, if the eNB transmits the INITIAL CONTEXT SETUP REQUEST message including the indication for indicating that the subsequent message is transmitted, the eNB may perform 3-step operations after receiving the INITIAL CONTEXT SETUP REQUEST message in step 2-2 without immediately performing step 3. Therefore, the signaling overhead may be reduced or resource waste may be reduced.

On the contrary, when one message for the relay UE and the remote UE is transmitted, each message may include an identifier for distinguishing the UEs and IEs may be separately included for each UE identifier.

The relay UE receives an indication that the user plane bearer (i.e., DRB) is established in the AS layer to recognize that the Service Request procedure according to FIG. 20 is successfully completed. In this case, the indication may include the following information.
An object in which the user plane bearer is successfully established: Information for specifying whether the object in which the user plane bearer is successfully established is the relay UE or the remote UE or both UEs may be included.
A list of successfully established bearers may be separately indicated for each UE.

Meanwhile, when the Service Request procedure according to FIG. 20 is performed, the network may reject the corresponding Service Request. In this case, a SERVICE REJECT message transmitted by the network (i.e., MME/SGSN) may include the following information.
An object of rejection: Information for identifying whether the reject object of the service request is the relay UE or the remote UE or both UEs may be included. In this case, a reject cause may be explicitly delivered for each UE.
The relay UE or the remote UE may release the direct link according to the reject cause.

[1-3] Method for Individually Performing Service Request Procedure

In the present invention, it is assumed that when the relay UE performs the Service Request procedure, the ‘Service Request procedure for the relay UE’ and the ‘Service Request procedure for the remote UE’ are separately individually performed.

1. Triggering Condition for Service Request Procedure

A triggering condition under which the relay UE performs the Service Request procedure is as follows.

1) Triggering Condition for ‘Service Request Procedure’ for ‘Relay UE’
The ‘Service Request procedure of the relay UE’ may be triggered when the relay UE is switched from the EMM-IDLE to the EMM-CONNECTED mode.

In this case, the relay UE itself means a case where the triggering condition (see the condition that the Service Request procedure described above is initiated/triggered) of the Service Request procedure is satisfied.
The ‘Service Request procedure of the relay UE’ may be triggered when the relay UE receives the paging message therefor in the EMM-CONNECTED mode.

2) Triggering Condition for ‘Service Request Procedure for Remote UE’
The ‘Service Request procedure of the remote UE’ may be triggered when the relay UE receives the paging message for the remote UE.
The ‘Service Request procedure of the remote UE’ may be triggered when the relay UE recognizes that the remote UE needs to send the signaling or data to the network.

In this case, a method in which the relay UE recognizes that the remote UE needs to send the signaling or data to the network is as follows.

The remote UE transmits corresponding signaling (e.g., an NAS signaling message) or data to the relay UE via the PC5 interface or an indication or message indicating that there is signaling or data to be transmitted to the network by the remote UE via the PC5 interface to the UE, and as a result, the relay UE may recognize that the signaling or data is transmitted.
The relay UE may be in the EMM-IDLE mode or EMM-CONNECTED mode.

2) Triggering Condition for ‘Service Request Procedure for Both Remote UE and Relay UE’
Both the ‘Service Request procedure of the relay UE’ and the ‘Service Request procedure for the remote UE’ are performed when the paging message jointly for the relay UE and the remote UE is received.

In this case, when both Service Request procedures are simultaneously (together) performed, the method described in [1-2] above is applied.

Alternatively, in this case, each UE may sequentially perform the Service Request procedure.
The paging message jointly for the relay UE and the remote UE may include group identifiers for both UEs.

The ‘Service Request procedure for the remote UE’ described above is performed even when the relay UE is in the EMM-CONNECTED mode in addition to the EMM-IDLE mode.

2. Performing Service Request Procedure

1) Even when the relay UE is in the EMM-IDLE mode or EMM-CONNECTED mode, the relay UE may perform the Service Request procedure for the relay UE′ or the ‘Service Request procedure for the remote UE’.

2) An operation of performing the Service Request procedure according to each mode of the relay UE is as follows.

A. Case where the Relay UE is in the EMM-IDLE Mode

The relay UE may recognize that performing the Service Request procedure of the relay UE is successfully completed when an indication that the user plane bearer (DRB) is established is received from the AS layer of the relay UE.

In this case, when the Service Request procedure is successfully performed, the relay UE is switched to the EMM-CONNECTED mode.

That is, even when the ‘Service Request procedure for the remote UE’ is successfully completed, the relay UE may be switched to the EMM-CONNECTED mode.

B. Case where the Relay UE is in the EMM-CONNECTED Mode

The procedure performed at this time may be the existing Service Request procedure or a newly defined NAS procedure.

In this case, the NAS message which the relay UE transmits to perform the Service Request procedure may be the SERVICE REQUEST message, an EXTENDED SERVICE REQUEST message, or a CONTROL PLANE SERVICE REQUEST message in the related art. Further, the TAU REQUEST message with an active flag set may be used.

In addition, the NAS message which the relay UE transmits to perform the Service Request procedure may be the newly defined NAS message.

3) When the paging message jointly for the relay UE and the remote UE is received, the relay UE performs both the ‘Service Request procedure of the relay UE’ and the ‘Service Request procedure for the remote UE’.

A. When each Service Request procedure is sequentially performed, the ‘Service Request procedure of the relay UE’ may be first performed.

The reason is that since the signaling of the remote UE may be required through the PC5 interface in order to perform the ‘Service Request procedure for the remote UE’, the delay may occur. The relay UE may perform the signaling through the PC5 interface while performing the ‘Service Request procedure of the relay UE’ and perform the ‘Service Request procedure for the remote UE’ after completing performing the signaling. A more detailed performing order related thereto will be described below in ‘2. Relay UE operation in [2]’.

3. Additional Information

In the above description, when the triggering condition is satisfied and the service request procedure is performed for both UEs, in order to set up the DRB of the remote UE, the relay UE may add and transmit the indication (e.g., the active flag for the remote UE) together with the NAS signaling message (e.g., a SERVICE REQUEST message, an EXTENDED SERVICE REQUEST message, a TAU REQUEST message, and a CONTROL PLANE SERVICE REQUEST message).

The MME receiving the indication may perform an operation for establishing the SRB and the DRB of the relay UE and the DRB for the remote UE. That is, the above indication serves to establish the DRB of the remote UE.

If the triggering condition for the remote UE is satisfied, when the relay UE is in the EMM-IDLE mode, the indication is classified into the following cases according to whether the DRB of the relay UE is also established.
Case where the DRB of the relay UE is also established: The operation is similarly performed when the triggering condition for both UEs is satisfied.
Case where the DRB of the relay UE is not established: An operation for establishing only the SRB of the relay UE and the DRB of the remote UE is performed. Such an operation may be performed through the following procedure.

The indication (e.g., the active flag for the remote UE) or the identifier (e.g., GUTI or S-TMSI) of the remote UE may be included in the NAS message and transmitted. The MME receiving the indication or the identifier of the remote UE may perform an operation for establishing the DRB of the remote UE. In this case, the NAS message may be the TAU REQUEST message or the CONTROL PLANE SERVICE REQUEST message. Further, the NAS message may be the newly defined NAS message.

On the contrary, if the triggering condition for the remote UE is satisfied, when the relay UE is in the EMM-CONNECTED mode, the operation for establishing only the DRB of the remote UE may be performed. Such an operation may be performed through the following procedure.

The indication (e.g., the active flag for the remote UE) or the identifier (e.g., GUTI or S-TMSI) of the remote UE may be included in the NAS message and transmitted. The MME receiving the indication or the identifier of the remote UE may perform an operation for establishing the DRB of the remote UE. In this case, the NAS message may be the TAU REQUEST message or the CONTROL PLANE SERVICE REQUEST message. Further, the NAS message may be the newly defined NAS message.

Further, in this case, the relay UE operates as if the relay UE is in the EMM-IDLE mode (i.e., the DRB establishment request for the relay UE) and even if the relay UE receives the corresponding NAS message from the network, the relay UE recognizes that the relay UE is in the EMM-CONNECTED mode to ignore the request for establishing the DRB of the relay UE. In this case, the relay UE operates as if the triggering condition for both UEs is satisfied, but the network (i.e., MME) recognizes that the relay UE is EMM-CONNECTED to ignore the request for establishing the DRB of the relay UE.

[1-4] Matters Commonly Applied to [1-2] and [1-3] Above

According to the above description,

A. A method in which the relay UE recognizes that the remote UE needs to send the signaling or data to the network is as follows.
The remote UE transmits the corresponding signaling (e.g., NAS signaling message) or data to the relay UE through the PC5 interface, or
the remote UE sends the indication or message that ‘there is signaling or data to be sent to the network’ to the relay UE through the PC5 interface, and as a result, the relay UE may recognize that the remote UE needs to send the signaling or data to the network.

An operation sequence of the remote UE in this case is as follows.

a) The remote UE may be restricted from direct communication with the network via the Uu interface until the direct link with the relay UE is established and released. In other words, even if the remote UE is in-coverage, the remote UE may not communicate directly with the network.

b) The NAS layer of the remote UE may recognize that signaling or data to be transmitted from a higher layer (e.g., an application layer) to the network is generated in the remote UE.

c) The NAS layer of the remote UE may recognize that the NAS signaling may not be transmitted to the network in step a) above. Therefore, the remote UE may inform the relay UE that the remote UE needs to transmit the signaling or data to the network. The method is as follows.

The NAS layer of the remote UE may generate the NAS message (e.g., the SERVICE REQUEST message, the EXTENDED SERVICE REQUEST message, the TAU REQUEST message, the CONTROL PLANE SERVICE REQUEST message, etc.) similarly to the related art. In this case, the NAS layer of the remote UE may deliver the indication indicating that ‘there is the signaling or data to be transmitted to the network’ to the ProSe layer of the remote UE together.

In this case, when the ProSe layer of the remote UE receives the NAS message from the NAS layer, the ProSe layer encapsulates the NAS message in the PC5 message and passes the corresponding message to a lower layer (i.e., the AS layer). When the ProSe layer of the remote UE receives the aforementioned indication from the NAS layer, the ProSe layer encapsulates the corresponding indication in the PC5 message and passes the PC5 message encapsulated with the corresponding indication to the lower layer (i.e., the AS layer).

The lower layer (i.e., the AS layer) of the remote UE that receives the message from the ProSe layer may transmit the corresponding PC5 message to the relay UE.

[2] Paging Procedure for Layer 2 Relay

The relationship between the relay UE and the remote UE may be recognized in the network, optimized handling may be performed, and the operation in the related art may be performed.

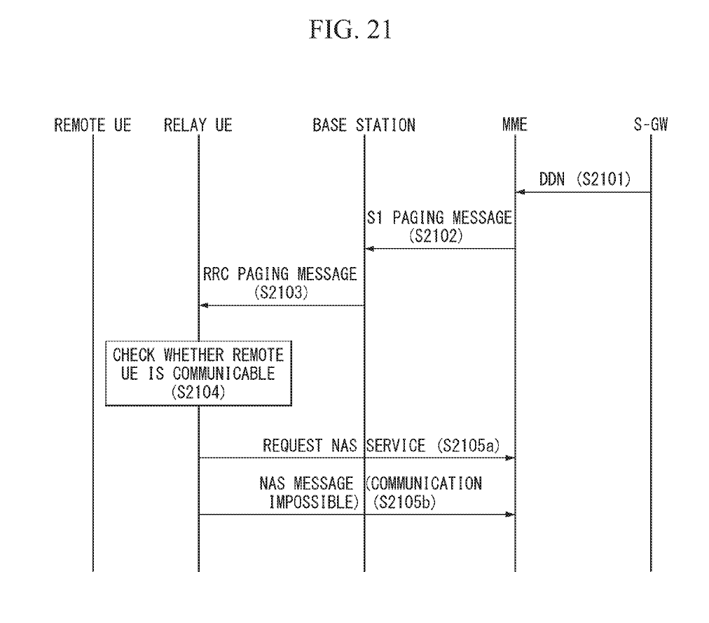

FIG. 21 illustrates a paging procedure for a layer-2 relay according to an embodiment of the present invention.

Referring to FIG. 21, when the MME receives a Downlink Data Notification (DDN) from the S-GW (S2101), the MME transmits an S1 interface paging message to the base station (S2102) and the base station transmits an RRC paging message to the relay UE based on the S1 interface paging message (52103).

In this case, even if the relay UE is in the EMM-CONNECTED mode, when the MME receives the Downlink Data Notification (DDN) for the remote UE, the MME may transmit a paging message for notifying that there is downlink data to be transmitted to the remote UE to the relay UE.

On the contrary, if the relay UE is in the EMM-IDLE mode, when the MME receives the DDN for the relay UE or the remote UE, the MME may transmit the paging message for the UE or remote UE to the relay UE.

Further, if the relay UE is in the EMM-IDLE mode, when the MME receives the DDN for both the relay UE and the remote UE, the MME may transmit the paging message for both the relay UE and the remote UE to the relay UE. In this case, the paging message jointly for the relay UE and the remote UE may include a group identifier for both UEs.

Here, the network may transmit the paging message to the relay UE by the following scheme.
The relay UE may monitor the paging message only at a paging occasion thereof. In this case, the network may encapsulate an indication indicating that the paging message is for the relay UE or the remote UE in the paging message delivered to the relay UE.
Alternatively, the relay UE may monitor the paging message even at the paging occasion in addition to the paging occasion thereof. In this case, the network may operate in the same scheme as the related art.

When the relay UE receives the paging message for the remote UE from the base station, the relay UE checks whether the remote UE may directly communicate (S2104).

Here, the relay UE may perform a procedure for checking whether the remote UE may directly communicate as follows. That is, the relay UE needs to check whether the relay UE is alive with the remote UE. In other words, the relay UE may check whether the remote UE is in a communicable state (e.g., a distance or signaling strength between the remote UE and the relay UE). The corresponding procedure may be performed as follows.

In this case, such a procedure may be performed before the relay UE transmits the signaling or data to the remote UE.

a) The relay UE may transmit a PC5 first message to the remote UE.

b) When the remote UE receives the corresponding PC5 first message, the remote UE may respond to the relay UE through a PC5 second message.

In this case, the remote UE may encapsulate the NAS message (e.g., the SERVICE REQUEST message, the EXTENDED SERVICE REQUEST message, and the CONTROL PLANE SERVICE REQUEST message) or information for performing the Service Request procedure for the remote UE by the relay UE in the corresponding PC5 second message.

c) The relay UE that receives the corresponding PC5 second message from the remote UE may recognize that the remote UE is alive. That is, the relay UE may determine that the relay UE is communicable with the remote UE.

In this case, when the relay UE may not receive a response (i.e., PC5 second message) from the remote UE, the relay UE may retransmit the PC5 first message and when the relay UE may not receive the response from the remote UE even after a predetermined number of retransmission times, the relay UE may regard that the remote UE is not alive (i.e., not communicable).

When the relay UE confirms that the remote UE is alive, the relay UE may perform the service request procedure for the remote UE. In this case, the performing method is described in [1-2] or [1-3] described above.

On the contrary, when the relay UE regards that the remote UE is not alive, the relay UE informs the network (i.e., MME) that the relay UE is not communicable with the remote UE. The network that receives the information that the relay UE is not communicable with the remote UE may stop the paging procedure for the corresponding remote UE.

[3] TAU Procedure for Layer 2 Relay

When the relay UE intends to transmit contents (i.e., uplink data or signaling) of the remote UE together at the time of performing the TAU procedure, a transmission method of the contents of the remote UE is as follows.

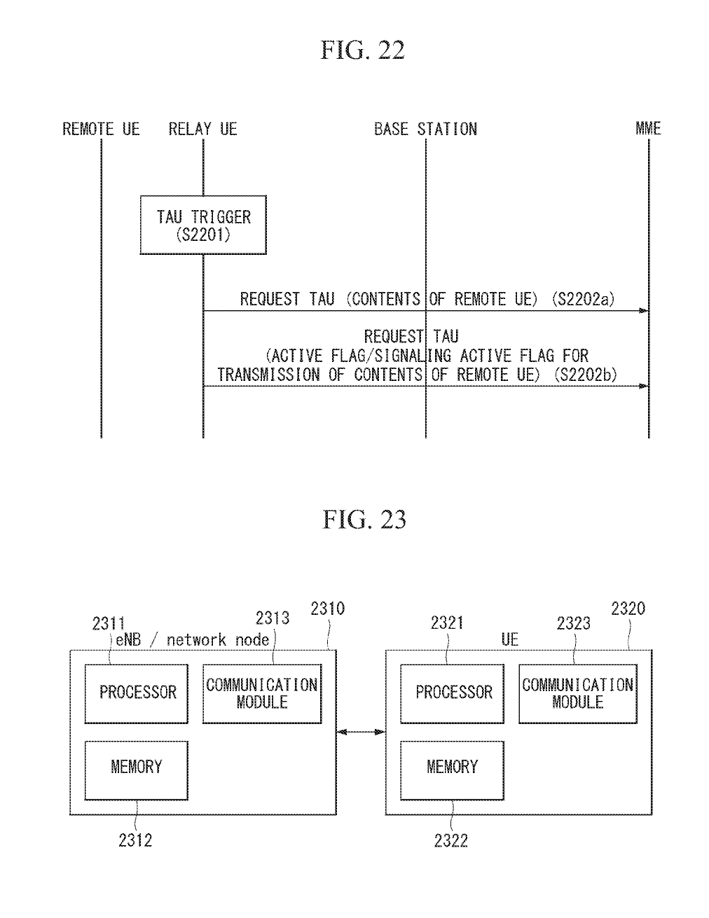

FIG. 22 illustrates a tracking area update procedure for a layer-2 relay according to an embodiment of the present invention.

Referring to FIG. 22, if the triggering condition for initiating the TAU procedure by the relay UE is satisfied (S2201), the relay UE transmits a TAU request message to the MME (S2202a and S2202b).

In this case, like S2202a, when the contents of the remote UE is transmitted together with the TAU REQUEST message of the relay UE, the contents of the remote UE may be included in a container of the TAU REQUEST message of the relay UE and transmitted.

Alternatively, after the TAU procedure of the relay UE is successfully completed, the contents of the remote UE may be included in a separate NAS message and delivered to the MME.

In this case, like S2202b, in order to prevent the NAS connection from being released immediately after the TAU procedure of the relay UE is successfully completed, the active flag or a signaling active flag may be included in the TAU REQUEST message and transmitted. Thereafter, a separate NAS message carrying the contents of the remote UE may be the TAU REQUEST message in the related art or the newly defined NAS message.

Meanwhile, in the description of the present invention, the relationship between one relay UE and one remote UE has been described for the convenience of description, but even when one relay UE and several remote UEs are used, the method according to the present invention described above may be similarly applied. The present invention is described on the assumption that the MME of the relay UE and the MME of the remote UE are the same as each other. However, the present invention may be applied even to a case where the MME of the relay UE and the MME of the remote UE are different from each other.

Overview of Devices to which Present Invention is Applicable

FIG. 23 illustrates a block diagram of a communication apparatus according to an embodiment of the present invention.

Referring to FIG. 23, a wireless communication system includes a network node 2310 and multiple user equipments 2320.

The network node 2310 includes a processor 2311, a memory 2312, and a communication module 2313. The processor 2311 implements a function, a process, and/or a method which are proposed in FIGS. 1 to 22 above. Layers of a wired/wireless interface protocol may be implemented by the processor 2311.

The memory 2312 is connected with the processor 2311 to store various pieces of information for driving the processor 2311. The communication module 2313 is connected with the processor 2311 to transmit and/or receive a radio signal. An example of the network node 2310 may correspond to a base station, MME, HSS, SGW, PGW, SCEF, SCS/AS, etc. In particular when the network node 2310 is the base station, the communication module 2313 may include a radio frequency (RF) unit for transmitting/receiving a radio signal.

The UE 2320 includes a processor 2321, a memory 2322, and a communication module (or RF unit) 2323. The processor 2321 implements a function, a process, and/or a method which are proposed in FIGS. 1 to 22 above. The layers of the wireless interface protocol may be implemented by the processor 2321. In particular, the processor may include an NAS layer and an AS layer. The memory 2322 is connected with the processor 2321 to store various pieces of information for driving the processor 2321. The communication module 2323 is connected with the processor 2321 to transmit and/or receive a radio signal.

The memories 2312 and 2322 may be positioned inside or outside the processors 2311 and 2321 and connected with the processors 2311 and 2321 by various well-known means. Further, the network node 2310 (when the network node 2320 is the base station) and/or the UE 2820 may have a single antenna or multiple antennas.

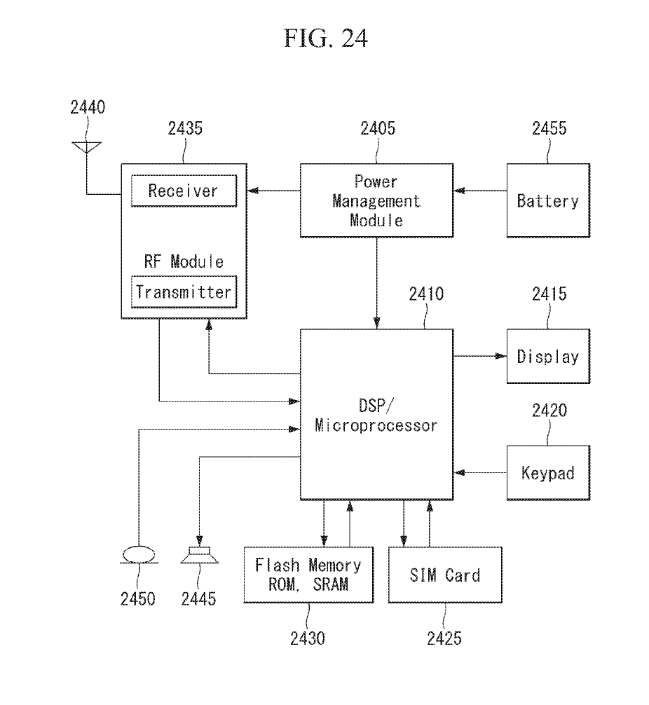

FIG. 24 illustrates a block diagram of a communication apparatus according to an embodiment of the present invention.

In particular, FIG. 24 is a diagram more specifically illustrating the UE of FIG. 23 above.

Referring to FIG. 24, the UE may be configured to include a processor (or a digital signal processor (DSP) 2410, an RF module (or RF unit) 2435, a power management module 2405, an antenna 2440, a battery 2455, a display 2415, a keypad 2420, a memory 2430, a subscriber identification module (SIM) card 2425 (This component is optional), a speaker 2445, and a microphone 2450. The UE may also include a single antenna or multiple antennas.

The processor 2410 implements a function, a process, and/or a method which are proposed in FIGS. 1 to 22 above. Layers of a wireless interface protocol may be implemented by the processor 2410.

The memory 2430 is connected with the processor 2410 to store information related to an operation of the processor 2410. The memory 2430 may be positioned inside or outside the processor 2410 and connected with the processor 2410 by various well-known means.

A user inputs command information such as a telephone number or the like by, for example, pressing (or touching) a button on the keypad 2420 or by voice activation using the microphone 2450. The processor 2410 receives such command information and processes to perform appropriate functions including dialing a telephone number. Operational data may be extracted from the SIM card 2425 or the memory 2430. In addition, the processor 2410 may display command information or drive information on the display 2415 for the user to recognize and for convenience.

The RF module 2435 is connected with the processor 2410 to transmit and/or receive an RF signal. The processor 2410 transfers the command information to the RF module 2435 to initiate communication, for example, to transmit radio signals constituting voice communication data. The RF module 2435 is constituted by a receiver and a transmitter for receiving and transmitting the radio signals. The antenna 2440 functions to transmit and receive the radio signals. Upon receiving the radio signals, the RF module 2435 may transfer the signal for processing by the processor 2410 and convert the signal to a baseband. The processed signal may be converted into to audible or readable information output via the speaker 2445.

The aforementioned embodiments are achieved by combination of structural elements and features of the present invention in a predetermined manner Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention may be achieved by various means, for example, hardware, firmware, software, or a combination thereof. In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. Software code may be stored in a memory unit and executed by a processor. The memory unit may be located at the interior or exterior of the processor and may transmit data to and receive data from the processor via various known means.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The present invention is applied to a 3GPP LTE/LTE-A system is primarily described, but may be applied to various wireless communication systems, particularly 5G (5 generation) systems, in addition to the 3GPP LTE/LTE-A system.

What is claimed is:

1. A method for performing, by a base station, a service request procedure triggered by a remote UE when a connection between a relay user equipment (UE) and a remote UE is set up in a wireless communication system, the method comprising:
receiving, from the relay UE, a radio resource management (RRC) message encapsulated with a service request message for the remote UE, which includes an identifier of the remote UE;
transmitting the service request message to a mobile management entity (MME) within an S1 interface message;
receiving, from the MME, an S1 initial context setup request message for the remote UE without UE radio capability information of the remote UE; and
storing the UE radio capability information of the relay UE as the UE radio capability information of the remote UE.

2. The method of claim 1, wherein the S1 interface initial context setup request message includes an indicator indicating that the remote UE is connected to the relay UE and the relay UE transmits/receives traffic of the remote UE, or the identifier of the relay UE and/or the identifier of the remote UE.

3. The method of claim 1, further comprising:
performing a radio bearer setup procedure for the relay UE and the remote UE based on the UE radio capability information of the relay UE.

4. The method of claim 3, wherein the performing of the radio bearer setup includes
transmitting, to the relay UE, an RRC connection reconfiguration for modifying an RRC connection, and
receiving, from the relay UE, an RRC connection reconfiguration complete message for confirming successful completion of RRC connection reconfiguration.

5. The method of claim 1, wherein when a paging message for the remote UE is transmitted to the relay UE, transmission of the service request message is triggered.

6. The method of claim 5, wherein in a case where the paging message for the remote UE is transmitted to the relay UE, when the relay UE determines that communication with the remote UE is impossible, it is notified from the relay UE to a network that the communication with the remote UE is impossible.

7. The method of claim 1, wherein when the paging message for both the relay UE and the remote UE is transmitted to the relay UE, the transmission of the service request message is triggered, and
wherein the paging message includes a group identifier for the relay UE and the remote UE.

8. The method of claim 1, wherein when the relay UE receives, from the remote UE, a signaling or data which the remote UE is to transmit through the network, the transmission of the service request message is triggered.

9. The method of claim 1, wherein when the relay UE receives, from the remote UE, an indication for indicating that there is the signaling or data which the remote UE is to transmit through the network, the transmission of the service request message is triggered.

10. The method of claim 1, wherein when the S1 interface initial context setup request message for the relay UE is received following the S1 interface initial context setup request message for the remote UE within the service request procedure,
an indication for indicating that the S1 interface initial context setup request message for the relay UE following the S1 interface initial context setup request message for the remote UE is included.

11. The method of claim 1, wherein when the S1 interface initial context setup request message for the remote UE and the S1 interface initial context setup request message for the relay UE is received are transmitted as a single message,
the identifier of the remote UE and the identifier of the relay UE are included in the single message and an information element is separately included for each identifier.

12. The method of claim 1, wherein the relay UE is in an evolved packet system (EPS) mobility management (EMM)-idle mode or EMM-connected mode.

13. The method of claim 1, wherein the service request message includes an indicator or an active flag for requesting establishment of a data radio bearer for the remote UE.

14. A base station performing a service request procedure triggered by a remote UE when a connection between a relay user equipment (UE) and a remote UE is set up in a wireless communication system, the base station comprising:
a communication module transmitting/receiving a signal; and
a processor controlling the communication module,
the processor is configured to
receive, from the relay UE, a radio resource management (RRC) message encapsulated with a service request message for the remote UE, which includes an identifier of the remote UE,
transmit the service request message to a mobile management entity (MME) within an S1 interface message,
receive, from the MME, an S1 initial context setup request message for the remote UE without UE radio capability information of the remote UE, and
store the UE radio capability information of the relay UE as the UE radio capability information of the remote UE.
